(19) United States
(12) Patent Application Publication
(10) Pub. No.: US 2021/0045092 A1
(43) Pub. Date: Feb. 11, 2021

(54) BASE STATION APPARATUS AND TERMINAL APPARATUS

(71) Applicants: SHARP KABUSHIKI KAISHA, Sakai City, Osaka (JP); FG Innovation Company Limited, Tuen Mun, New Territories (HK)

(72) Inventors: JUNGO GOTOH, Sakai City, Osaka (JP); SEIJI SATO, Sakai City, Osaka (JP); OSAMU NAKAMURA, Sakai City, Osaka (JP); YASUHIRO HAMAGUCHI, Sakai City, Osaka (JP)

(21) Appl. No.: 16/965,143

(22) PCT Filed: Jan. 8, 2019
(86) PCT No.: PCT/JP2019/000234

§ 371 Date: Jul. 27, 2020

(30) Foreign Application Priority Data
Jan. 30, 2018 (JP) 2018-013398

(51) Int. Cl. H04W 72/04; H04W 76/27; H04W 52/08; H04W 52/54; H04L 27/26; H04L 5/00

(52) U.S. Cl. CPC H04W 72/04; H04W 76/27; H04L 5/0053; H04W 52/54; H04L 27/26; H04W 52/08

(57) ABSTRACT

A terminal apparatus for communicating with a base station apparatus, the terminal apparatus including: a receiver configured to receive control information; and a transmitter configured to perform data transmission in accordance with the control information, wherein the receiver receives at least RRC and DCI, the RRC includes configuration of a target received power, a fractional TPC, and an index of a closed loop TPC to be used for PUSCH transmission, and information for indicating at least a target received power, a fractional TPC, and an index of a closed loop TPC as parameters for transmission power control to be switched depending on the DCI, and in a case that the DCI for indicating switching of a transmission power value is detected, a transmission power used for data transmission is caused to be different from a transmission power value calculated using parameters notified as the parameters for transmission power control to be switched.

### TECHNICAL FIELD

An aspect of the present invention relates to a base station apparatus, a terminal apparatus, and a communication method for these apparatuses.

This application claims priority based on JP 2018-13398 filed on Jan. 30, 2018, the contents of which are incorporated herein by reference.

### BACKGROUND ART

In recent years, 5th Generation (5G) mobile telecommunication systems have been focused on, and a communication technology is expected to be specified, the technology establishing MTC mainly based on a large number of terminal apparatuses (Massive Machine Type Communications; mMTC), Ultra-Reliable and Low Latency Communications (URLLC), and enhanced Mobile BroadBand (eMBB). The 3rd Generation Partnership Project (3GPP) has been studying New Radio (NR) as a 5G communication technique and discussing NR Multiple Access (MA).

In 5G, Internet of Things (IoT) which allows connection of various types of equipment not previously connected to a network is expected to be established, and establishment of mMTC is an important issue. In 3GPP, a Machine-to-Machine (M2M) communication technology has already been standardized as Machine Type Communication (MTC) that accommodates terminal apparatuses transmitting and/or receiving small size data (NPL 1). Furthermore, in order to support data transmission at a low rate in a narrow band, standardization of Narrow Band-IoT (NB-IoT) has been conducted (NPL 2). 5G is expected to accommodate more terminals than the above-described standards and to accommodate IoT equipment requiring ultra-reliable and low-latency communications.

On the other hand, in communication systems such as Long Term Evolution (LTE) and LTE-Advanced (LTE-A) which are specified by the 3GPP, terminal apparatuses (User Equipment (UE)) use a Random Access Procedure, a Scheduling Request (SR), and the like, to request a radio resource for transmitting uplink data to a base station apparatus (also referred to as a Base Station (BS) or an evolved Node B (eNB)). The base station apparatus provides uplink transmission grant (UL Grant) to each terminal apparatus based on an SR. In a case that the terminal apparatus receives an UL Grant as control information from the base station apparatus, the terminal apparatus transmits uplink data using a given radio resource (referred to as Scheduled access, grant-based access, or transmission by dynamic scheduling, and hereinafter referred to as scheduled access), based on uplink transmission parameters included in the UL Grant. In this manner, the base station apparatus controls all uplink data transmissions (the base station apparatus knows radio resources for uplink data transmitted by each terminal apparatus). In the scheduled access, the base station apparatus can establish Orthogonal Multiple Access (OMA) by controlling uplink radio resources.

G mMTC includes a problem in that the use of the scheduled access increases the amount of control information. URLLC includes a problem in that the use of the scheduled access increases delay. As such, a study is underway to utilize grant free access and Semi-Persistent Scheduling (SPS, also referred to as Type2 configured grant transmission), where in the grant free access (also referred to as grant free access, grant less access, Contention-based access, Autonomous access, Resource allocation for uplink transmission without grant, type1 configured grant transmission, or the like, and hereinafter referred to as grant free access) the terminal apparatus transmits data without performing random access procedure or SR transmission and without performing UL Grant reception, or the like (NPL 3). In the grant free access, increased overhead associated with control information can be suppressed even in a case that a large number of devices transmit small size data. Furthermore, in the grant free access, no UL Grant reception or the like is performed, and thus, the time from generation to transmission of transmission data can be shortened. In the SPS, some of the transmission parameters are notified by use of higher layer control information, and notification is made with an activation UL Grant that indicates the transmission parameters not notified by the higher layer and an approval of use of a periodic resource to enable the data transmission.

Since URLLC needs to ensure high reliability and low latency at the same time, a study is underway to use repetitive transmissions of data. In order to realize the URLLC in the scheduled access, high reliability of control information for DL Grant and UL Grant needs to be ensured because DL Grant and UL Grant are received at each time of data transmission or reception.

### CITATION LIST

### Non Patent Literature

NPL 1: 3GPP, TR36.888 V12.0.0, “Study on provision of low-cost Machine-Type Communications (MTC) User Equipments (UEs) based on LTE,” June 2013
NPL 2: 3GPP, TR45.820 V13.0.0, “Cellular system support for ultra-low complexity and low throughput Internet of Things (CIoT),” August 2015
NPL 3: 3GPP, TS38.214 V2.0.0, “Physical layer procedures for data (Release 15),” December 2017

### SUMMARY OF INVENTION

### Technical Problem

In realizing URLLC, there is a problem that the delay time is longer in a case that high reliability is achieved with repetitive transmission of the same data (the same transport block).

An aspect of the present invention has been made in view of such circumstances, and an object of the present invention is to provide a base station apparatus, a terminal apparatus, and a communication method capable of improving reliability in a case of transmitting a transport block one time.

### Solution to Problem

To address the above-mentioned drawbacks, a base station apparatus, a terminal apparatus, and a communication method according to an aspect of the present invention are configured as follows.

(1) An aspect of the present invention is a terminal apparatus for communicating with a base station apparatus, the terminal apparatus including: a receiver configured to receive control information; and a transmitter configured to perform data transmission in accordance with the control information, wherein the receiver receives at least RRC and DCI, the RRC includes configuration of a target received power, a fractional TPC, and an index of a closed loop TPC to be used for PUSCH transmission, and information for indicating at least a target received power, a fractional TPC, and an index of a closed loop TPC as parameters for transmission power control to be switched depending on the DCI, and in a case that the DCI for indicating switching of a transmission power value is detected, a transmission power used for data transmission is caused to be different from a transmission power value calculated using parameters notified as the parameters for transmission power control to be switched.

(2) In an aspect of the present invention, the DCI for indicating the switching of the transmission power value is configured with at least one of conditions of an RNTI, an aggregation level, a search space, and the number of OFDM symbols used for data transmission that are configured through the RRC, and the transmission power control is switched in accordance with the condition.

(3) In an aspect of the present invention, the DCI indicating the switching of the transmission power value causes switching of the transmission power control in a case that a value of a Validation field in the DCI for activation of SPS Type 2 is different.

(4) In an aspect of the present invention, the DCI for indicating the switching of the transmission power value indicates switching of at least one of an MCS table, a CQI table, or a transmission mode of a PH reporting.

### Advantageous Effects of Invention

According to one or more aspects of the present invention, high reliable data transmission can be achieved.

### BRIEF DESCRIPTION OF DRAWINGS

FIG. 1 is a diagram illustrating an example of a communication system according to a first embodiment.

FIG. 2 is a diagram illustrating an example of a radio frame structure for the communication system according to the first embodiment.

FIG. 3 is a schematic block diagram illustrating a configuration of a base station apparatus 10 according to the first embodiment.

FIG. 4 is a diagram illustrating an example of a signal detection unit according to the first embodiment.

FIG. 5 is a schematic block diagram illustrating a configuration of a terminal apparatus 20 according to the first embodiment.

FIG. 6 is a diagram illustrating an example of the signal detection unit according to the first embodiment.

### DESCRIPTION OF EMBODIMENTS

A communication system according to the present embodiments includes a base station apparatus (also referred to as a cell, a small cell, a pico cell, a serving cell, a component carrier, an eNodeB (eNB), a Home eNodeB, a Low Power Node, a Remote Radio Head, a gNodeB (gNB), a control station, a Bandwidth Part (BWP), or a Supplementary Uplink (SUL)), and a terminal apparatus (also referred to as a terminal, a mobile terminal, a mobile station, or User Equipment (UE)). In the communication system, in case of a downlink, the base station apparatus serves as a transmitting apparatus (a transmission point, a transmit antenna group, or a transmit antenna port group), and the terminal apparatus serves as a receiving apparatus (a reception point, a reception terminal, a receive antenna group, or a receive antenna port group). In a case of an uplink, the base station apparatus serves as a receiving apparatus, and the terminal apparatus serves as a transmitting apparatus. The communication system is also applicable to Device-to-Device (D2D) communication. In this case, the terminal apparatus serves both as a transmitting apparatus and as a receiving apparatus.

The communication system is not limited to data communication between the terminal apparatus and the base station apparatus, the communication involving human beings, but is also applicable to a form of data communication requiring no human intervention, such as Machine Type Communication (MTC), Machine-to-Machine (M2M) Communication, communication for Internet of Things (IoT), or Narrow Band-IoT (NB-IoT) (hereinafter referred to as MTC). In this case, the terminal apparatus serves as an MTC terminal. The communication system can use, in the uplink and the downlink, a multi-carrier transmission scheme such DFTS-OFDM (Discrete Fourier Transform Spread-Orthogonal Frequency Division Multiplexing, also referred to as Single Carrier-Frequency Division Multiple Access (SC-FDMA)) and Cyclic Prefix-Orthogonal Frequency Division Multiplexing (CP-OFDM). The communication system can also use Filter Bank Multi Carrier (FBMC), Filtered-OFDM (f-OFDM) to which a filter is applied, Universal Filtered-OFDM (UF-OFDM), or Windowing-OFDM (W-OFDM), a transmission scheme using a sparse code (Sparse Code Multiple Access (SCMA)), or the like. Furthermore, the communication system may apply DFT precoding and use a signal waveform for which the filter described above is used. Furthermore, the communication system may apply code spreading, interleaving, the sparse code, and the like in the above-described transmission scheme. Note that, in the description below, at least one of the DFTS-OFDM transmission and the CP-OFDM transmission is used in the uplink, whereas the CP-OFDM transmission is used in the downlink but that the present embodiments are not limited to this configuration and any other transmission scheme is applicable.

The base station apparatus and the terminal apparatus according to the present embodiments can communicate in a frequency band for which an approval of use (license) has been obtained from the government of a country or region where a radio operator provides services, that is, a so-called licensed band, and/or in a frequency band for which no approval of use (license) from the government of the country or region is required, that is, a so-called unlicensed band. In the unlicensed band, communication may be based on carrier sense (e.g., a listen before talk scheme).

According to the present embodiments, “X/Y” includes the meaning of “X or Y”. According to the present embodiments, “X/Y” includes the meaning of “X and Y”. According to the present embodiments, “X/Y” includes the meaning of “X and/or Y”.

### First Embodiment

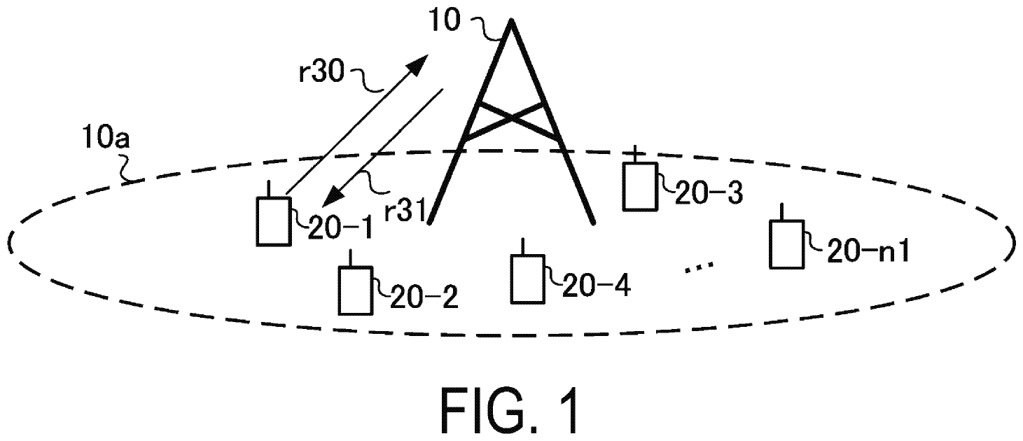

FIG. 1 is a diagram illustrating an example of a configuration of a communication system according to the present embodiment. The communication system according to the present embodiment includes a base station apparatus 10 and terminal apparatuses 20-1 to 20-n1 (n1 is a number of terminal apparatuses connected to the base station apparatus 10). The terminal apparatuses 20-1 and 20-n1 are also collectively referred to as terminal apparatuses 20. Coverage 10a is a range (a communication area) in which the base station apparatus 10 can connect to the terminal apparatus 20 (coverage 10a is also referred to as a cell).

In FIG. 1, radio communication of an uplink r30 includes at least the following uplink physical channels. The uplink physical channels are used for transmitting information output from a higher layer.
Physical Uplink Control Channel (PUCCH)
Physical Uplink Shared Channel (PUSCH)
Physical Random Access Channel (PRACH)

The PUCCH is a physical channel that is used to transmit Uplink Control Information (UCI). The uplink control information includes a positive acknowledgement (ACK)/Negative acknowledgement (NACK) in response to downlink data (a Downlink transport block, a Medium Access Control Protocol Data Unit (MAC PDU), a Downlink-Shared Channel (DL-SCH), and a Physical Downlink Shared Channel (PDSCH). The ACK/NACK is also referred to as a Hybrid Automatic Repeat request ACKnowledgement (HARQ-ACK), a HARQ feedback, a HARQ response, or a signal indicating HARQ control information or a delivery confirmation.

The uplink control information includes a Scheduling Request (SR) used to request a PUSCH (Uplink-Shared Channel (UL-SCH)) resource for initial transmission. The scheduling request includes a positive scheduling request or a negative scheduling request. The positive scheduling request indicates that a UL-SCH resource for initial transmission is requested. The negative scheduling request indicates that the UL-SCH resource for the initial transmission is not requested.

The uplink control information includes downlink Channel State Information (CSI). The downlink channel state information includes a Rank Indicator (RI) indicating a preferable spatial multiplexing order (the number of layers), a Precoding Matrix Indicator (PMI) indicating a preferable precoder, a Channel Quality Indicator (CQI) indicating a preferable transmission rate, and the like. The PMI indicates a codebook determined by the terminal apparatus. The codebook is related to precoding of the physical downlink shared channel. The CQI can use an index (CQI index) indicative of a preferable modulation scheme (for example, QPSK, 16QAM, 64QAM, 256QAM, or the like), a preferable coding rate, and a preferable frequency utilization efficiency in a prescribed band. The terminal apparatus selects, from the CQI table, a CQI index considered to allow a transport block on the PDSCH to be received within a prescribed block error probability (for example, an error rate of 0.1). Here, the terminal apparatus may have multiple prescribed error probabilities (error rates) for transport blocks. For example, an error rate for eMBB data may be targeted at 0.1 and an error rate for URLLC may be targeted 0.00001. The terminal apparatus may perform CSI feedback for each target error rate (transport block error rate) in a case of being configured by the higher layer (e.g., setup through RRC signaling from the base station), or may perform CSI feedback for a target error rate configured in a case that one of multiple target error rates is configured by the higher layer. Note that the CSI may be calculated using an error rate not for eMBB (e.g. 0.1) depending on not whether the error rate is configured through RRC signaling but whether a CQI table not for eMBB (that is, transmissions where the BLER does not exceed 0.1) is selected.

PUCCH formats 0 to 4 are defined for the PUCCH, and PUCCH formats 0 and 2 are transmitted in 1 to 2 OFDM symbols and PUCCH formats 1, 3, and 4 are transmitted in 4 to 14 OFDM symbols. PUCCH formats 0 and 1 are used for up to 2-bit notification, and can notify only the HARQ-ACK or simultaneously the HARQ-ACK and the SR. PUCCH formats 1, 3, and 4 are used for more than 2-bit notification, and can simultaneously notify the ARQ-ACK, the SR, and the CSI. The number of OFDM symbols used for PUCCH transmission is configured by a higher layer (e.g., setup through RRC signaling), and the use of any PUCCH format depends on whether there is SR transmission or CSI transmission at the timing at which the PUCCH is transmitted (slot, OFDM symbol).

The PUSCH is a physical channel that is used to transmit uplink data (Uplink Transport Block, Uplink-Shared Channel (UL-SCH)). The PUSCH may be used to transmit the HARQ-ACK in response to the downlink data and/or the channel state information along with the uplink data. The PUSCH may be used to transmit only the channel state information. The PUSCH may be used to transmit only the HARQ-ACK and the channel state information.

The PUSCH is used to transmit radio resource control (Radio Resource Control (RRC)) signaling. The RRC signaling is also referred to as an RRC message/RRC layer information/an RRC layer signal/an RRC layer parameter/an RRC information element. The RRC signaling is information/signal processed in a radio resource control layer. The RRC signaling transmitted from the base station apparatus may be signaling common to multiple terminal apparatuses in a cell. The RRC signaling transmitted from the base station apparatus may be signaling dedicated to a certain terminal apparatus (also referred to as dedicated signaling). In other words, user equipment-specific (UE-specific) information may be transmitted through signaling dedicated to the certain terminal apparatus. The RRC message can include a UE Capability of the terminal apparatus. The UE Capability is information indicating a function supported by the terminal apparatus.

The PUSCH is used to transmit a Medium Access Control Element (MAC CE). The MAC CE is information/signal processed (transmitted) in a Medium Access Control layer. For example, a Power Headroom (PH) may be included in the MAC CE and may be reported via the physical uplink shared channel. In other words, a MAC CE field is used to indicate a level of the power headroom. The uplink data can include the RRC message and the MAC CE. The RRC signaling and/or the MAC CE is also referred to as a higher layer signal (higher layer signaling). The RRC signaling and/or the MAC CE are included in a transport block.

The PRACH is used to transmit a preamble used for random access. The PRACH is used for indicating the initial connection establishment procedure, the handover procedure, the connection re-establishment procedure, synchronization (timing adjustment) for uplink transmission, and the request for the PUSCH (UL-SCH) resource.

In the uplink radio communication, an Uplink Reference Signal (UL RS) is used as an uplink physical signal. The uplink reference signal includes a Demodulation Reference Signal (DMRS) and a Sounding Reference Signal (SRS). The DMRS is associated with transmission of the physical uplink-shared channel/physical uplink control channel. For example, the base station apparatus 10 uses the demodulation reference signal to perform channel estimation/channel compensation in a case of demodulating the physical uplink-shared channel/physical uplink control channel. For an uplink DMRS, the maximum number of OFDM symbols for front-loaded DMRS and a configuration for the DMRS symbol addition (DMRS-add-pos) are indicated by the base station apparatus through the RRC. In a case that the front-loaded DMRS is in 1 OFDM symbol (single symbol DMRS), a frequency domain location, cyclic shift values in the frequency domain, and how different frequency domain locations are used in the OFDM symbol including the DMRS are indicated in the DCI, and in a case that the front-loaded DMRS is in 2 OFDM symbols (double symbol DMRS), a configuration for a time spread of a length 2 is indicated in the DCI in addition to the above.

The Sounding Reference Signal (SRS) is not associated with the transmission of the physical uplink shared channel/physical uplink control channel. In other words, with or without uplink data transmission, the terminal apparatus transmits periodically or aperiodically the SRS. In the periodic SRS, the terminal apparatus transmits the SRS based on parameters notified through signaling (e.g., RRC) from a layer higher than the base station apparatus. On the other hand, in the aperiodic SRS, the terminal apparatus transmits the SRS based on parameters notified through signaling (e.g., RRC) from a layer higher than the base station apparatus and a physical downlink control channel (for example, DCI) indicating a transmission timing of the SRS. The base station apparatus 10 uses the SRS to measure an uplink channel state (CSI Measurement). The base station apparatus 10 may perform timing alignment and closed loop transmission power control from measurement results obtained by receiving the SRS.

In FIG. 1, at least the following downlink physical channels are used in radio communication of the downlink r31. The downlink physical channels are used for transmitting information output from the higher layer.
Physical Broadcast Channel (PBCH)
Physical Downlink Control Channel (PDCCH)
Physical Downlink Shared Channel (PDSCH)

The PBCH is used for broadcasting a Master Information Block (MIB, a Broadcast Channel (BCH)) that is used commonly by the terminal apparatuses. The MIB is one of pieces of system information. For example, the MIB includes a downlink transmission bandwidth configuration and a System Frame number (SFN). The MIB may include information indicating at least some of numbers of a slot, a subframe, and a radio frame in which a PBCH is transmitted.

The PDCCH is used to transmit Downlink Control Information (DCI). For the downlink control information, multiple formats based on applications (also referred to as DCI formats) are defined. The DCI format may be defined based on the type and the number of bits of the DCI constituting a single DCI format. The downlink control information includes control information for downlink data transmission and control information for uplink data transmission. The DCI format for downlink data transmission is also referred to as downlink assignment (or downlink grant, DL Grant). The DCI format for uplink data transmission is also referred to as uplink grant (or uplink assignment, UL Grant).

The DCI format for downlink data transmission includes DCI format 1_0, DCI format 1_1, and the like. The DCI format 1_0 is for fallback downlink data transmission, and is constituted by bits the number of which is fewer than DCI format 1_1 supporting MIMO and the like. On the other hand, DCI format 1_1 is capable of notifying MIMO or multiple codewords transmission, ZP CSI-RS trigger, CBG transmission information, and the like, and a presence or absence, or the number of bits of some fields thereof are added in accordance with the configuration by the higher layer (e.g., RRC signaling, MAC CE). A single downlink assignment is used for scheduling a single PDSCH in a single serving cell. The downlink grant may be used for at least scheduling a PDSCH within the same slot/subframe as the slot/subframe in which the downlink grant has been transmitted. The downlink assignment in DCI format 1_0 includes the following fields. For example, the relevant fields include a DCI format identifier, a frequency domain resource assignment (resource block allocation for the PDSCH, resource allocation), a time domain resource assignment, VRB to PRB mapping, a Modulation and Coding Scheme (MCS) for the PDSCH (information indicating a modulation order and a coding rate), a NEW Data Indicator (NDI) indicating an initial transmission or retransmission, information for indicating the HARQ process number in the downlink, a Redundancy version (RV) indicating information on redundant bits added to the codeword during error correction coding, Downlink Assignment Index (DAI), a Transmission Power Control (TPC) command for the PUCCH, a resource indicator for the PUCCH, an indicator for HARQ feedback timing from the PDSCH, and the like. Note that the DCI format for each downlink data transmission includes information (fields) required for the application among the above-described information.

The DCI format for uplink data transmission includes DCI format 0_0, DCI format 0_1, and the like. The DCI format 0_0 is for fallback uplink data transmission, and is constituted by bits the number of which is fewer than DCI format 0_1 supporting MIMO and the like. On the other hand, DCI format 0_1 is capable of notifying MIMO or multiple codewords transmission, an SRS resource indicator, precoding information, antenna port information, SRS request information, CSI request information, CBG transmission information, uplink PTRS association, DMRS sequence initialization, and the like, and a presence or absence, or the number of bits of some fields thereof are added in accordance with the configuration by the higher layer (e.g., RRC signaling). A single uplink grant is used for notifying the terminal apparatus of scheduling of a single PUSCH in a single serving cell. The uplink grant in DCI format 0_0 includes the following fields. For example, the relevant fields include a DCI format identifier, a frequency domain resource assignment (information on resource block allocation for transmitting the PUSCH and a time domain resource assignment, a frequency hopping flag, information on the MCS for the PUSCH, RV, NDI, information indicating the HARQ process number in the uplink, a TPC command for the PUSCH, a Supplemental UL (UL/SUL) indicator, and the like.

For the MCS for the PDSCH/PUSCH, an index (MCS index) indicating a modulation order for the PDSCH/the PUSCH and a target coding rate can be used. The modulation order is associated with a modulation scheme. The modulation orders “2”, “4”, and “6” indicate “QPSK,” “16QAM,” and “64QAM,” respectively. Furthermore, in a case that 256QAM and 1024QAM are configured by the higher layer (e.g., RRC signaling), the modulation orders “8” and “10” can be notified, and indicate “256QAM” and “1024QAM”, respectively. The target coding rate is used to determine a transport block size (TBS) that is the number of bits to be transmitted, depending on the number of resource elements (the number of resource blocks) of the PDSCH/PUSCH scheduled in the PDCCH. A communication system 1 (the base station apparatus 10 and the terminal apparatus 20) shares a method of calculating the transport block size by the MCS, the target coding rate, and the number of resource elements (the number of resource blocks) allocated for the PDSCH/PUSCH transmission.

The PDCCH is generated by adding a Cyclic Redundancy Check (CRC) to the downlink control information. In the PDCCH, CRC parity bits are scrambled with a prescribed identifier (also referred to as an exclusive OR operation, mask). The parity bits are scrambled with a Cell-Radio Network Temporary Identifier (C-RNTI), a Configured Scheduling (CS)-RNTI, a Temporary C (TC)-RNTI, a Paging (P)-RNTI, a System Information (SI)-RNTI, a Random Access (RA)-RNTI, or with an INT-RNTI, a Slot Format Indicator (SFI)-RNTI, a TPC-PUSCH-RNTI, a TPC-PUCCH-RNTI, or a TPC-SRS-RNTI. The C-RNTI and the CS-RNTI are identifiers for identifying the terminal apparatus in a cell by the dynamic scheduling and the SPS/grant free access, respectively. The Temporary C-RNTI is an identifier for identifying the terminal apparatus that has transmitted a random access preamble in a contention based random access procedure. The C-RNTI and the Temporary C-RNTI are used to control PDSCH transmission or PUSCH transmission in a single subframe. The CS-RNTI is used to periodically allocate a resource for the PDSCH or the PUSCH. The P-RNTI is used to transmit a paging message (Paging Channel (PCH)). The SI-RNTI is used to transmit the SIB, and the RA-RNTI is used to transmit a random access response (message 2 in a random access procedure). The SFI-RNTI is used to notify a slot format. The INT-RNTI is used to notify a Pre-emption. The TPC-PUSCH-RNTI and the TPC-PUCCH-RNTI, and the TPC-SRS-RNTI are used to notify transmission power control values of the PUSCH and the PUCCH, and the SRS, respectively. Note that the identifier may include a CS-RNTI for each configuration in order to configure multiple grant free accesses/SPSs. The DCI to which the CRC scrambled with the CS-RNTI is added can be used for activation, deactivation, parameter change, or retransmission control (ACK/NACK transmission) of the grant free access, and the parameter may include a resource configuration (a configuration parameter for a DMRS, a resource in a frequency domain and a time domain of the grant free access, an MCS used for the grant free access, the number of repetitions, with or without applying a frequency hopping, and the like).

The PDSCH is used to transmit the downlink data (the downlink transport block, DL-SCH). The PDSCH is used to transmit a system information message (also referred to as a System Information Block (SIB)). Some or all of the SIBs can be included in the RRC message.

The PDSCH is used to transmit the RRC signaling. The RRC signaling transmitted from the base station apparatus may be common to the multiple terminal apparatuses in the cell (unique to the cell). That is, the information common to the user equipments in the cell is transmitted using RRC signaling unique to the cell. The RRC signaling transmitted from the base station apparatus may be a message dedicated to a certain terminal apparatus (also referred to as dedicated signaling). In other words, user equipment-specific (UE-Specific) information may be transmitted using a message dedicated to the certain terminal apparatus.

The PDSCH is used to transmit the MAC CE. The RRC signaling and/or the MAC CE is also referred to as a higher layer signal (higher layer signaling). The PMCH is used to transmit multicast data (Multicast Channel (MCH)).

In the downlink radio communication in FIG. 1, a Synchronization Signal (SS) and a Downlink Reference Signal (DL RS) are used as downlink physical signals.

The synchronization signal is used for the terminal apparatus to take synchronization in the frequency domain and the time domain in the downlink. The downlink reference signal is used for the terminal apparatus to perform the channel estimation/channel compensation on the downlink physical channel. For example, the downlink reference signal is used to demodulate the PBCH, the PDSCH, and the PDCCH. The downlink reference signal can be used for the terminal apparatus to measure the downlink channel state (CSI measurement). The downlink reference signal may include a Cell-specific Reference Signal (CRS), a Channel state information Reference Signal (CSI-RS), a Discovery Reference Signal (DRS), and a Demodulation Reference Signal (DMRS).

The downlink physical channel and the downlink physical signal are also collectively referred to as a downlink signal. The uplink physical channel and the uplink physical signal are also collectively referred to as an uplink signal. The downlink physical channel and the uplink physical channel are also collectively referred to as a physical channel. The downlink physical signal and the uplink physical signal are also collectively referred to as a physical signal.

The BCH, the UL-SCH, and the DL-SCH are transport channels. Channels used in the Medium Access Control (MAC) layer are referred to as transport channels. A unit of the transport channel used in the MAC layer is also referred to as a Transport Block (TB) or a MAC Protocol Data Unit (PDU). The transport block is a unit of data that the MAC layer delivers to the physical layer. In the physical layer, the transport block is mapped to a codeword, and coding processing and the like are performed for each codeword.

In higher layer processing, processing is performed on a layer higher than the physical layer, such as a Medium Access Control (MAC) layer, a Packet Data Convergence Protocol (PDCP) layer, a Radio Link Control (RLC) layer, and a Radio Resource Control (RRC) layer.

Processing is performed on a layer higher than the physical layer, such as a Medium Access Control (MAC) layer, a Packet Data Convergence Protocol (PDCP) layer, a Radio Link Control (RLC) layer, and a Radio Resource Control (RRC) layer.

A higher layer processing unit configures various RNTIs for each terminal apparatus. The RNTI is used for encryption (scrambling) of the PDCCH, the PDSCH, and the like. In the higher layer processing, the downlink data (transport block, DL-SCH) allocated to the PDSCH, the system information specific to the terminal apparatus (System Information Block: SIB), the RRC message, the MAC CE, and the like are generated or acquired from the higher node and transmitted. In the higher layer processing, various kinds of configuration information of the terminal apparatus 20 are managed. Note that a part of the function of the radio resource control may be performed in the MAC layer or the physical layer.

In the higher layer processing, information on the terminal apparatus, such as the function supported by the terminal apparatus (UE capability), is received from the terminal apparatus 20. The terminal apparatus 20 transmits its own function to the base station apparatus 10 by a higher layer signaling (RRC signaling). The information on the terminal apparatus includes information for indicating whether the terminal apparatus supports a prescribed function or information for indicating that the terminal apparatus has completed introduction and testing of the prescribed function. The information for indicating whether the prescribed function is supported includes information for indicating whether the introduction and testing of the prescribed function have been completed.

In a case that the terminal apparatus supports the prescribed function, the terminal apparatus transmits information (parameters) for indicating whether the prescribed function is supported. In a case that the terminal apparatus does not support a prescribed function, the terminal apparatus may not transmit information (parameters) for indicating whether the prescribed function is supported. In other words, whether the prescribed function is supported is notified by whether information (parameters) for indicating whether the prescribed function is supported is transmitted. The information (parameters) for indicating whether the prescribed function is supported may be notified by using one bit of 1 or 0.

In FIG. 1, the base station apparatus 10 and the terminal apparatuses 20 support, in the uplink, Multiple Access (MA) using the grant free access (also referred to grant free access, grant less access, Contention-based access, Autonomous access, Resource allocation for uplink transmission without grant, type1 configured grant transmission, or the like, and hereinafter referred to as grant free access). The grant free access is a scheme in which the terminal apparatus transmits uplink data (such as a physical uplink channel) without performing a procedure to transmit a SR by the terminal apparatus and indicate a physical resource and transmission timing of data transmission by use of a UL Grant using the DCI by the base station apparatus (also referred to as UL Grant through L1 signaling). Thus, the terminal apparatus can receive, through RRC signaling (SPS-config), in advance as Configured Uplink Grant in RRC signaling, a physical resource (resource assignment in the frequency domain, resource assignment in the time domain) that can be used for grant free access and a transmission parameter (that may include a cyclic shift of DMRS, OCC, an antenna port number, a position or the number of OFDM symbols in which DMRS is allocated, the number of repetitive transmissions of the same transport, and the like) in addition to a resource allocation period that can be used, a target received power, a value (a) of fractional TPC, the number of HARQ processes, and an RV pattern during repetitive transmission of the same transport, and perform data transmission using the configured physical resource only in a case that the transmission data is in the buffer. In other words, in a case that the higher layer does not deliver transport blocks to transmit in the grant free access, data transmission in grant free access is not performed. In a case that the terminal apparatus receives SPS-config, but does not receive Configured Uplink Grant in RRC signaling, the terminal apparatus can also perform similar data transmission in the SPS (type2 configured grant transmission) by SPS activation via the UL Grant.

There are two types of grant free access as follows. A first type is type1 configured grant transmission (UL-TWG-type), that is a scheme in which the base station apparatus transmits transmission parameters for the grant free access to the terminal apparatus through higher layer signaling (e.g., RRC), and transmits start of grant (activation, RRC setup) and end of grant (deactivation, RRC release) of the data transmission in the grant free access, and change of the transmission parameters also through higher layer signaling. Here, the transmission parameters for the grant free access may include a physical resource (resource assignment in the time domain and the frequency domain) that can be used for data transmission in the grant free access, a period of the physical resource, an MCS, with or without applying repetitive transmission, the number of repetitions, an RV configuration for repetitive transmission, with or without applying a frequency hopping, a hopping pattern, a DMRS configuration (the number of OFDM symbols for front-loaded DMRS, configurations of cyclic shift and time spread, or the like), the number of HARQ processes, information on transformer precoder, and information on a configuration for TPC. The transmission parameters and the start of grant of the data transmission related to the grant free access may be simultaneously configured, or the start of grant of the data transmission in the grant free access may be configured at different timings (in a case of an SCell, SCell activation, etc.) after the transmission parameters for the grant free access are configured. A second type is type2 configured grant transmission (UL-TWG-type2), that is a scheme in which the base station apparatus transmits transmission parameters for the grant free access to the terminal apparatus through higher layer signaling (e.g., RRC), and transmits start of grant (activation) and end of grant (deactivation) of the data transmission in the grant free access, and change of the transmission parameters through DCI (L1 signaling). Here, a period of the physical resource in RRC, the number of repetitions, an RV configuration for repetitive transmission, the number of HARQ processes, information on transformer precoder, and information on a configuration for TPC may be included, and the start of grant (activation) based on the DCI may include a physical resource (resource block allocation) that can be used for the grant free access. The transmission parameters and the start of grant of the data transmission related to the grant free access may be simultaneously configured, or the start of grant of the data transmission in the grant free access may be configured at different timings after the transmission parameters for the grant free access are configured. The present invention may be applied to any grant free access described above.

On the other hand, Semi-Persistent Scheduling (SPS) technology is introduced in LTE, and periodic resource allocation is possible mainly in VoIP (Voice over Internet Protocol) applications. In the SPS, the DCI is used to perform start of grant (activation) by use of an UL Grant including the transmission parameters such as a physical resource indication (resource blocks allocation) and an MCS. Thus, two types (UL-TWG-type1) performing the start of grant (activation) in the grant free access through higher layer signaling (e.g., RRC) differ from the SPS in the starting procedure. The UL-TWG-type2 is the same as the SPS in that the start of grant (activation) is performed by use of the DCI (L1 signaling), but may be different from the SPS in that it can be used in the SCell, the BWP, and the SUL, and the number of repetitions and an RV configuration for repetitive transmission are notified through RRC signaling. The base station apparatus may perform scrambling with the RNTI types of which are different between the DCI (L1 signaling) used for the grant free access (UL-TWG-type1 and UL-TWG-type2) and the DCI used for the dynamic scheduling, or may perform scrambling with the RNTI the same between the DCI used for the retransmit control of the UL-TWG-type1 and the DCI used for the activation and deactivation and the retransmit control of the UL-TWG-type2.

The base station apparatus 10 and the terminal apparatuses 20 may support non-orthogonal multiple access in addition to orthogonal multiple access. Note that the base station apparatus 10 and the terminal apparatuses 20 can support both the grant free access and scheduled access. Here, a “scheduled access” refers to the terminal apparatus 20 transmitting data according to the following procedure. The terminal apparatus 20 requests a radio resource for transmitting uplink data to the base station apparatus 10 using the random access procedure (Random Access Procedure) or the SR. The base station apparatus provides an UL Grant to each terminal apparatus based on the RACH or the SR by use of the DCI. In a case that the terminal apparatus receives an UL Grant as the control information from the base station apparatus, the terminal apparatus transmits uplink data using a prescribed radio resource based on an uplink transmission parameter included in the UL Grant.

The downlink control information for physical channel transmission in the uplink may include a shared field shared between the scheduled access and the grant free access. In this case, in a case that the base station apparatus 10 indicates transmission of the uplink physical channel using the grant free access, the base station apparatus 10 and the terminal apparatus 20 interpret a bit sequence stored in the shared field in accordance with a configuration for the grant free access (e.g., a look-up table defined for the grant free access). Similarly, in a case that the base station apparatus 10 indicates transmission of the uplink physical channel using the scheduled access, the base station apparatus 10 and the terminal apparatus 20 interpret the shared field in accordance with a configuration for the scheduled access. Transmission of the uplink physical channel in the grant free access is referred to as Asynchronous data transmission. Note that the transmission of the uplink physical channel in the scheduled is referred to as Synchronous data transmission.

In the grant free access, the terminal apparatus 20 may randomly select a radio resource for transmission of uplink data. For example, the terminal apparatus 20 has been notified, by the base station apparatus 10, of multiple candidates for available radio resources as a resource pool, and randomly selects a radio resource from the resource pool. In the grant free access, the radio resource in which the terminal apparatus 20 transmits the uplink data may be configured in advance by the base station apparatus 10. In this case, the terminal apparatus 20 transmits the uplink data using the radio resource configured in advance without receiving the UL Grant (including a physical resource indication) in the DCI. The radio resource includes multiple uplink multiple access resources (resources to which the uplink data can be mapped). The terminal apparatus 20 transmits the uplink data by using one or more uplink multiple access resources selected from the multiple uplink multiple access resources. Note that the radio resource in which the terminal apparatus 20 transmits the uplink data may be predetermined in the communication system including the base station apparatus 10 and the terminal apparatus 20. The radio resource for transmission of the uplink data may be notified to the terminal apparatus 20 by the base station apparatus 10 using a physical broadcast channel (e.g., Physical Broadcast Channel (PBCH)/Radio Resource Control (RRC)/system information (e.g. System Information Block (SIB)/physical downlink control channel (downlink control information, e.g., Physical Downlink Control Channel (PDCCH), Enhanced PDCCH (EPDCCH), MTC PDCCH (MPDCCH), and Narrowband PDCCH (NPDCCH)).

In the grant free access, the uplink multiple access resource includes a multiple access physical resource and a Multi-Access Signature Resource. The multiple access physical resource is a resource including time and frequency. The multiple access physical resource and the multi-access signature resource may be used to identify the uplink physical channel transmitted by each terminal apparatus. The resource blocks are units to which the base station apparatus 10 and the terminal apparatus 20 are capable of mapping the physical channel (e.g., the physical data shared channel or the physical control channel). Each of the resource blocks includes one or more subcarriers (e.g., 12 subcarriers or 16 subcarriers) in a frequency domain.

The multi-access signature resource includes at least one multi-access signature of multiple multi-access signature groups (also referred to as multi-access signature pools). The multi-access signature is information indicating a characteristic (mark or indicator) that distinguishes (identifies) the uplink physical channel transmitted by each terminal apparatus. Examples of the multi-access signature include a spatial multiplexing pattern, a spreading code pattern (a Walsh code, an Orthogonal Cover Code (OCC), a cyclic shift for data spreading, the sparse code, or the like), an interleaving pattern, a demodulation reference signal pattern (a reference signal sequence, the cyclic shift, the OCC, or IFDM)/an identification signal pattern, and transmission power, at least one of which is included in the multi-access signature. In the grant free access, the terminal apparatus 20 transmits the uplink data by using one or more multi-access signatures selected from the multi-access signature pool. The terminal apparatus 20 can notify the base station apparatus 10 of available multi-access signatures. The base station apparatus 10 can notify the terminal apparatus of a multi-access signature used by the terminal apparatus 20 to transmit the uplink data. The base station apparatus 10 can notify the terminal apparatus 20 of an available multi-access signature group by the terminal apparatus 20 to transmit the uplink data. The available multi-access signature group may be notified by using the broadcast channel/RRC/system information/downlink control channel. In this case, the terminal apparatus 20 can transmit the uplink data by using a multi-access signature selected from the notified multi-access signature group.

The terminal apparatus 20 transmits the uplink data by using a multiple access resource. For example, the terminal apparatus 20 can map the uplink data to a multiple access resource including a multi-carrier signature resource including one multiple access physical resource, a spreading code pattern, and the like. The terminal apparatus 20 can also allocate the uplink data to a multiple access resource including a multi-carrier signature resource including one multiple access physical resource and an interleaving pattern. The terminal apparatus 20 can also map the uplink data to a multiple access resource including a multi-access signature resource including one multiple access physical resource and a demodulation reference signal pattern/identification signal pattern. The terminal apparatus 20 can also map the uplink data to a multiple access resource including one multiple access physical resource and a multi-access signature resource including a transmission power pattern (e.g., the transmission power for each of the uplink data may be configured to cause a difference in receive power at the base station apparatus 10). In such grant free access, the communication system of the present embodiment may allow the uplink data transmitted by the multiple terminal apparatuses 20 to overlap (be superimposed, spatial multiplex, non-orthogonally multiplex, collide) with one another in the uplink multiple access physical resource to transmit.

The base station apparatus 10 detects, in the grant free access, a signal of the uplink data transmitted by each terminal apparatus. To detect the uplink data signal, the base station apparatus 10 may include Symbol Level Interference Cancellation (SLIC) in which interference is canceled based on a demodulation result for an interference signal, Codeword Level Interference Cancellation (CWIC, also referred to as Sequential Interference Canceler (SIC) or Parallel Interference Canceler (PIC)) in which interference is canceled based on the decoding result for the interference signal, turbo equalization, maximum likelihood detection (MLD, Reduced complexity maximum likelihood detection (R-MLD)) in which transmit signal candidates are searched for the most probable signal, Enhanced Minimum Mean Square Error-Interference Rejection Combining (EMMSE-IRC) in which interference signals are suppressed by linear computation, signal detection based on message passing (Belief Propagation (BP), Matched Filter (MF)-BP in which a matched filter is combined with BP, or the like.

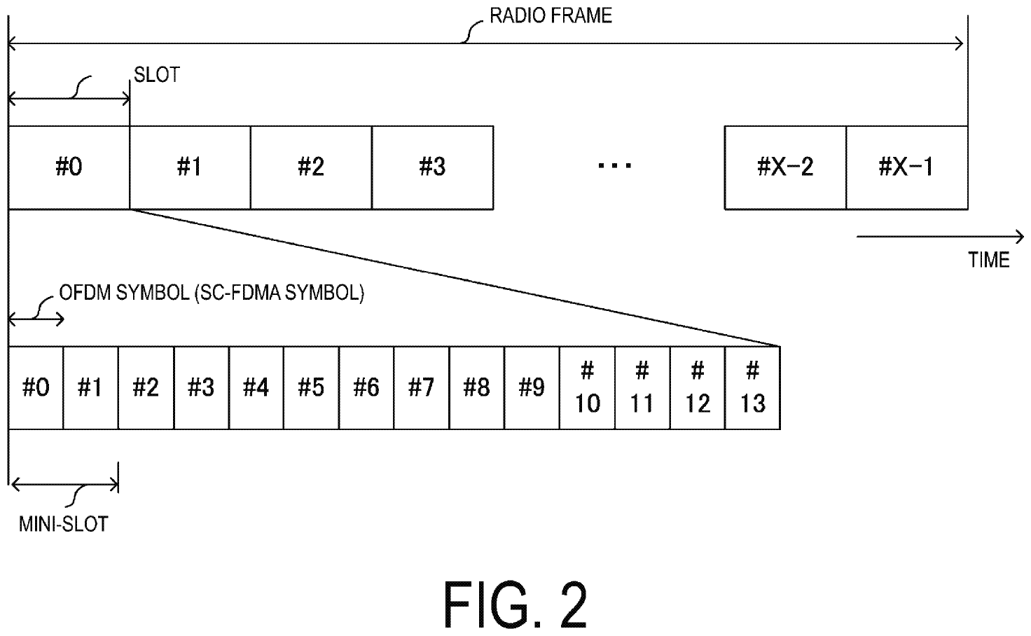

FIG. 2 is a diagram illustrating an example of a radio frame structure for a communication system according to the present embodiment. The radio frame structure indicates a configuration of multiple access physical resources in a time domain. One radio frame includes multiple slots (or may include subframes). FIG. 2 is an example in which one radio frame includes 10 slots. The terminal apparatus 20 has a subcarrier spacing used as a reference (reference numerology). The subframe includes multiple OFDM symbols generated at the subcarrier spacings used as the reference. FIG. 2 is an example in which a subcarrier spacing is 15 kHz, one frame includes 10 slots, one subframe includes one slot, and one slot includes 14 OFDM symbols. In the case that the subcarrier spacing is 15 kHz×2μ(μ is an integer of 0 or more), one frame includes 2μ×10 slots and one subframe includes 2μ slots.

FIG. 2 illustrates a case where the subcarrier spacing used as the reference is the same as a subcarrier spacing used for the uplink data transmission. The communication system according to the present embodiment may use slots as minimum units to which the terminal apparatus 20 maps the physical channel (e.g., the physical data shared channel or the physical control channel). In this case, in the multiple access physical resource, one slot is defined as a resource block unit in the time domain. Furthermore, in the communication system according to the present embodiment, a minimum unit for mapping the physical channel by the terminal apparatus 20 may be one or multiple OFDM symbols (e.g., 2 to 13 OFDM symbols). The base station apparatus 10 has one or multiple OFDM symbols serving as a resource block unit in the time domain. The base station apparatus 10 may signal a minimum unit for mapping a physical channel to the terminal apparatus 20.

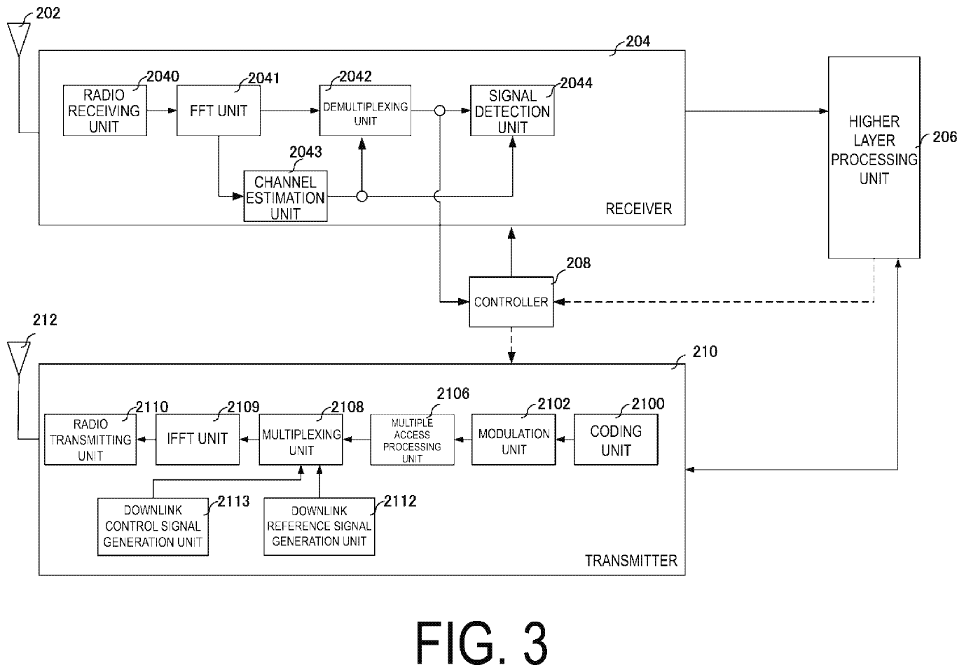

FIG. 3 is a schematic block diagram illustrating a configuration of the base station apparatus 10 according to the present embodiment. The base station apparatus 10 includes a receive antenna 202, a receiver (receiving step) 204, a higher layer processing unit (higher layer processing step) 206, a controller (control step) 208, a transmitter (transmitting step) 210, and a transmit antenna 212. The receiver 204 includes a radio receiving unit (radio receiving step) 2040, an FFT unit 2041 (FFT step), a demultiplexing unit (demultiplexing step) 2042, a channel estimation unit (channel estimating step) 2043, and a signal detection (signal detecting step) 2044. The transmitter 210 includes a coding unit (coding step) 2100, a modulation unit (modulation step) 2102, a multiple access processing unit (multiple access processing step) 2106, a multiplexing unit (multiplexing step) 2108, a radio transmitting unit (radio transmitting step) 2110, a IFFT unit (IFFT step) 2109, a downlink reference signal generation unit (downlink reference signal generation step) 2112, and a downlink control signal generation unit (downlink control signal generation step) 2113.

The receiver 204 demultiplexes, demodulates, and decodes an uplink signal (uplink physical channel, uplink physical signal) received from the terminal apparatus 10 via the receive antenna 202. The receiver 204 outputs a control channel (control information) separated from the received signal to the controller 208. The receiver 204 outputs a decoding result to the higher layer processing unit 206. The receiver 204 acquires the SR and the ACK/NACK and CSI for the downlink data transmission included in the received signal.

The radio receiving unit 2040 converts, by down-conversion, an uplink signal received through the receive antenna 202 into a baseband signal, removes unnecessary frequency components from the baseband signal, controls an amplification level in such a manner as to suitably maintain a signal level, orthogonally demodulates the signal based on an in-phase component and an orthogonal component of the received signal, and converts the resulting orthogonally-demodulated analog signal into a digital signal. The radio receiving unit 2040 removes a portion of the digital signal resulting from the conversion, the portion corresponding to a Cyclic Prefix (CP). The FFT unit 2041 performs a fast Fourier transform on the downlink signal from which CP has been removed (demodulation processing for OFDM modulation), and extracts the signal in the frequency domain.

The channel estimation unit 2043 uses the demodulation reference signal to perform channel estimation for signal detection for the uplink physical channel. The channel estimation unit 2043 receives as inputs, from the controller 208, the resources to which the demodulation reference signal is mapped and the demodulation reference signal sequence allocated to each terminal apparatus. The channel estimation unit 2043 uses the demodulation reference signal sequence to measure the channel state between the base station apparatus 10 and the terminal apparatus 20. The channel estimation unit 2043, in a case of the grant free access, can identify the terminal apparatus by using the result of channel estimation (impulse response and frequency response with the channel state) (the channel estimation unit 2043 is thus also referred to as an identification unit). The channel estimation unit 2043 determines that an uplink physical channel has been transmitted by the terminal apparatus 20 associated with the demodulation reference signal from which the channel state has been successfully extracted. In the resource on which the uplink physical channel is determined by the channel estimation unit 2043 to have been transmitted, the demultiplexing unit 2042 extracts the signal in the frequency domain input from the FFT unit 2041 (the signal includes signals from multiple terminal apparatuses 20).

The demultiplexing unit 2042 separates and extracts the uplink physical channel (physical uplink control channel, physical uplink shared channel) and the like included in the extracted uplink signal in the frequency domain. The demultiplexing unit outputs the physical uplink channel to the signal detection unit 2044/controller 208.

The signal detection unit 2044 uses the channel estimation result estimated by the channel estimation unit 2043 and the signal in the frequency domain input from the demultiplexing unit 2042 to detect a signal of uplink data (uplink physical channel) from each terminal apparatus. The signal detection unit 2044 performs detection processing for a signal from the terminal apparatus 20 associated with the demodulation reference signal (demodulation reference signal from which the channel state has been successfully extracted) allocated to the terminal apparatus 20 determined to have transmitted the uplink data.

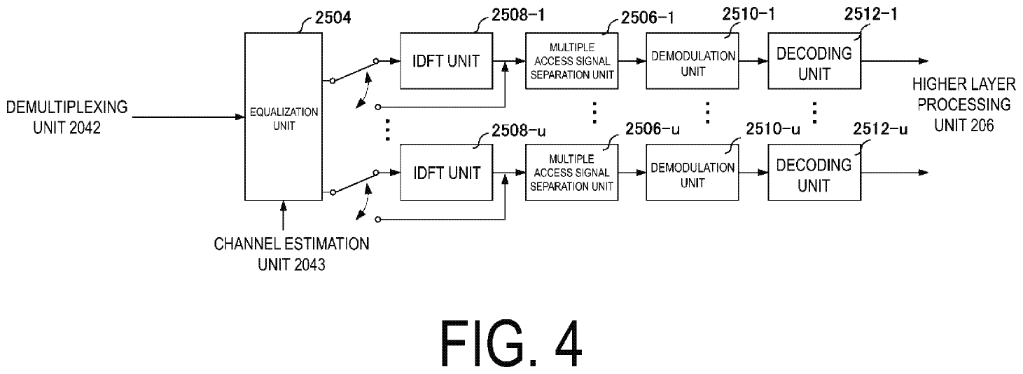

FIG. 4 is a diagram illustrating an example of the signal detection unit according to the present embodiment. The signal detection unit 2044 includes an equalization unit 2504, multiple access signal separation units 2506-1 to 2506-u, IDFT units 2508-1 to 2508-u, demodulation units 2510-1 to 2510-u, and decoding units 2512-1 to 2512-u. u, in the case of the grant free access, is the number of terminal apparatuses determined by the channel estimation unit 2043 to have transmitted uplink data (for which the channel state has been successfully extracted) on the same multiple access physical resource or overlapping multiple access physical resources (at the same time and at the same frequency). u, in the case of the scheduled access, is the number of terminal apparatuses allowed to transmit uplink data on the same multiple access physical resource or overlapping multiple access physical resources in the DCI (at the same time, for example, OFDM symbols, slots). Each of the portions constituting the signal detection unit 2044 is controlled using the configuration related to the grant free access for each terminal apparatus and input from the controller 208.

The equalization unit 2504 generates an equalization weight based on the MMSE standard, from the frequency response input from the channel estimation unit 2043. Here, MRC and ZF may be used for the equalization processing. The equalization unit 2504 multiplies the equalization weight by the signal (including a signal of each terminal apparatus) in the frequency domain input from the demultiplexing unit 2042, and extracts the signal in the frequency domain for the terminal apparatus. The equalization unit 2504 outputs the equalized signal in the frequency domain from each terminal apparatus to the IDFT units 2508-1 to 2508-u. Here, in a case that data is to be detected that is transmitted by the terminal apparatus 20 and that uses the DFTS-OFDM signal waveform, the signal in the frequency domain is output to the IDFT units 2508-1 to 2508-u. In a case that data is to be received that is transmitted by the terminal apparatus 20 and that uses the OFDM signal waveform, the signal in the frequency domain is output to the multiple access signal separation units 2506-1 to 2506-u.

The IDFT units 2508-1 to 2508-u converts the equalized signal in the frequency domain from each terminal apparatus into a signal in the time domain. Note that the IDFT units 2508-1 to 2508-u correspond to processing performed by the DFT unit of the terminal apparatus 20. The multiple access signal separation units 2506-1 to 2506-u separate the signal multiplexed by the multi-access signature resource from the signal in the time domain from each terminal apparatus after conversion with the IDFT (multiple access signal separation processing). For example, in a case that code spreading is used as a multi-access signature resource, each of the multiple access signal separation units 2506-1 to 2506-u performs inverse spreading processing using the spreading code sequence assigned to each terminal apparatus. Note that, in a case that interleaving is applied as a multi-access signature resource, de-interleaving is performed on the signal in the time domain from each terminal apparatus after conversion with the IDFT (de-interleaving unit).

The demodulation units 2510-1 to 2510-u receive as an input, from the controller 208, pre-notified or predetermined information about the modulation scheme (BPSK, QPSK, 16QAM, 64QAM, 256QAM, and the like) of each terminal apparatus. Based on the information about the modulation scheme, the demodulation units 2510-1 to 2510-u perform demodulation processing on the separated multiple access signal, and outputs a Log Likelihood Ratio (LLR) of the bit sequence.

The decoding units 2512-1 to 2512-u receive as an input, from the controller 208, pre-notified or predetermined information about the coding rate. The decoding units 2512-1 to 2512-u perform decoding processing on the LLR sequences output from the demodulation units 2510-1 to 2510-u, and output the decoded uplink data/unlink control information to the higher layer processing unit 206. In order to perform cancellation processing such as a Successive Interference Canceller (SIC) or turbo equalization, the decoding units 2512-1 to 2512-u may generate replicas from external LLRs or post LLRs output from the decoding units and perform the cancellation processing. A difference between the external LLR and the post LLR is whether to subtract, from the decoded LLR, the pre LLR input to each of the decoding units 2512-1 to 2512-u. In a case that the number of repetitions of SIC or turbo equalization is larger than or equal to a prescribed value, the decoding units 2512-1 to 2512-u may perform hard decision on the LLR resulting from the decoding processing, and may output the bit sequence of the uplink data for each terminal apparatus to the higher layer processing unit 206. Note that the signal detection is not limited to that using the turbo equalization processing, and can be replaced with signal detection based on replica generation and using no interference cancellation, maximum likelihood detection, EMMSE-IRC, or the like.

The controller 208 controls the receiver 204 and the transmitter 210 by using the configuration information related to the uplink reception/configuration information related to the downlink transmission included in the uplink physical channel (physical uplink control channel, physical uplink shared channel, or the like) (notified from the base station apparatus to the terminal apparatus by use of the DCI, RRC, SIB, and the like). The controller 208 acquires the configuration information related to the uplink reception/configuration information related to the downlink transmission from the higher layer processing unit 206. In a case that the transmitter 210 transmits the physical downlink control channel, the controller 208 generates Downlink Control Information (DCI) and outputs the generated information to the transmitter 210. Note that some of the functions of the controller 108 can be included in the higher layer processing unit 102. Note that the controller 208 may control the transmitter 210 in accordance with the parameter of the CP length added to the data signal.

The higher layer processing unit 206 performs processing of layers higher than the physical layer, such as the Medium Access Control (MAC) layer, the Packet Data Convergence Protocol (PDCP) layer, the Radio Link Control (RLC) layer, and the Radio Resource Control (RRC) layer. The higher layer processing unit 206 generates information needed to control the transmitter 210 and the receiver 204, and outputs the resultant information to the controller 208. The higher layer processing unit 206 outputs downlink data (e.g., the DL-SCH), broadcast information (e.g., the BCH), a Hybrid Automatic Request indicator (HARQ indicator), and the like to the transmitter 210. The higher layer processing unit 206 receives information, as an input, from the receiver 204, related to a function of the terminal apparatus (UE capability) supported by the terminal apparatus. For example, the higher layer processing unit 206 receives, through signaling in the RRC layer, information related to the function of the terminal apparatus.

The information related to the function of the terminal apparatus includes information indicating whether the terminal apparatus supports a prescribed function, or information indicating that the terminal apparatus has completed introduction and testing of a prescribed function. The information for indicating whether the prescribed function is supported includes information for indicating whether the introduction and testing of the prescribed function have been completed. In a case that the terminal apparatus supports the prescribed function, the terminal apparatus transmits information (parameters) for indicating whether the prescribed function is supported. In a case that the terminal apparatus does not support the prescribed function, the terminal apparatus may be configured not to transmit information (parameters) for indicating whether the prescribed function is supported. In other words, whether the prescribed function is supported is notified by whether information (parameters) for indicating whether the prescribed function is supported is transmitted. The information (parameters) for indicating whether the prescribed function is supported may be notified by using one bit of 1 or 0.

The information related to the function of the terminal apparatus includes information indicating that the grant free access is supported (information on whether or not each of the UL-TWG-type1 and the UL-TWG-type2 is supported). In a case that multiple functions corresponding to the grant free access are provided, the higher layer processing unit 206 can receive information indicating whether the grant free access is supported on a function-by-function basis. The information indicating that the grant free access is supported includes information indicating the multiple access physical resource and multi-access signature resource supported by the terminal apparatus. The information indicating that the grant free access is supported may include a configuration of a lookup table for the configuration of the multiple access physical resource and the multi-access signature resource. The information indicating that the grant free access is supported may include some or all of an antenna port, a capability corresponding to multiple tables indicating a scrambling identity and the number of layers, a capability corresponding to a prescribed number of antenna ports, and a capability corresponding to a prescribed transmission mode. The transmission mode is determined by the number of antenna ports, transmission diversity, the number of layers, and whether support of the grant free access and the like are provided.

The higher layer processing unit 206 manages various types of configuration information about the terminal apparatus. Some of the various types of configuration information are input to the controller 208. The various types of configuration information are transmitted from the base station apparatus 10 via the transmitter 210 using the downlink physical channel. The various types of configuration information include configuration information related to the grant free access input from the transmitter 210. The configuration information related to the grant free access includes configuration information about the multiple access resources (multiple access physical resources and multi-access signature resources). For example, the configuration information related to the grant free access may include a configuration related to the multi-access signature resource (configuration related to processing performed based on a mark for identifying the uplink physical channel transmitted by the terminal apparatus 20), such as an uplink resource block configuration (a starting position of the OFDM symbol to be used, the number of OFDM symbols/the number of resource blocks), a configuration of the demodulation reference signal/identification signal (reference signal sequence, cyclic shift, OFDM symbols to be mapped, and the like), a spreading code configuration (Walsh code, Orthogonal Cover Code (OCC), sparse code, spreading rates of these spreading codes, and the like), an interleaving configuration, a transmission power configuration, a transmit and/or receive antenna configuration, and a transmit and/or receive beamforming configuration. These multi-access signature resources may be directly or indirectly associated (linked) with one another. The association of the multi-access signature resources is indicated by a multi-access signature process index. The configuration information related to the grant free access may include the configuration of the look-up table for the configuration of the multiple access physical resource and multi-access signature resource. The configuration information related to the grant free access may include setup of the grant free access, information indicating release, ACK/NACK reception timing information for uplink data signals, retransmission timing information for uplink data signals, and the like.

Based on the configuration information related to the grant free access that is notified as the control information, the higher layer processing unit 206 manages multiple access resources (multiple access physical resources, multi-access signature resources) for the uplink data (transport blocks) in grant free. Based on the configuration information related to the grant free access, the higher layer processing unit 206 outputs, to the controller 208, information used to control the receiver 204.

The higher layer processing unit 206 outputs generated downlink data (e.g., DL-SCH) to the transmitter 210. The downlink data may include a field storing the UE ID (RNTI). The higher layer processing unit 206 adds the CRC to the downlink data. The CRC parity bits are generated using the downlink data. The CRC parity bits are scrambled with the UE ID (RNTI) allocated to the destination terminal apparatus (the scrambling is also referred to as an exclusive-OR operation, masking, or ciphering). However, as described above, the multiple types of RNTI are provided, which are different depending on the data being transmitted, and the like.

The higher layer processing unit 206 generates or acquires from a higher node, system information (MIB, SIB) to be broadcasted. The higher layer processing unit 206 outputs, to the transmitter 210, the system information to be broadcasted. The system information to be broadcasted can include information indicating that the base station apparatus 10 supports the grant free access. The higher layer processing unit 206 can include, in the system information, a portion or all of the configuration information related to the grant free access (such as the configuration information related to the multiple access resources such as the multiple access physical resource, the multi-access signature resource). The uplink system control information is mapped to the physical broadcast channel/physical downlink shared channel in the transmitter 210.

The higher layer processing unit 206 generates or acquires from a higher node, downlink data (transport blocks) to be mapped to the physical downlink shared channel, system information (SIB), an RRC message, a MAC CE, and the like, and outputs the downlink data and the like to the transmitter 210. The higher layer processing unit 206 can include, in the higher layer signaling, some or all of the configuration information related to the grant free access and parameters indicating setup and/or release of the grant free access. The higher layer processing unit 206 may generate a dedicated SIB for notifying the configuration information related to the grant free access.

The higher layer processing unit 206 maps the multiple access resources to the terminal apparatuses 20 supporting the grant free access. The base station apparatus 10 may hold a lookup table of configuration parameters for the multi-access signature resource. The higher layer processing unit 206 allocates each configuration parameter to the terminal apparatuses 20. The higher layer processing unit 206 uses the multi-access signature resource to generate configuration information related to the grant free access for each terminal apparatus. The higher layer processing unit 206 generates a downlink shared channel including a portion or all of the configuration information related to the grant free access for each terminal apparatus. The higher layer processing unit 206 outputs, to the controller 208/transmitter 210, the configuration information related to the grant free access.

The higher layer processing unit 206 configures a UE ID for each terminal apparatus and notifies the terminal apparatus of the UE ID. As the UE ID, a Cell Radio Network Temporary Identifier (RNTI) can be used. The UE ID is used for the scrambling of the CRC added to the downlink control channel and the downlink shared channel. The UE ID is used for scrambling of the CRC added to the uplink shared channel. The UE ID is used to generate an uplink reference signal sequence. The higher layer processing unit 206 may configure a SPS/grant free access-specific UE ID. The higher layer processing unit 206 may configure the UE ID separately depending on whether or not the terminal apparatus supports the grant free access. For example, in a case that the downlink physical channel is transmitted in the scheduled access and the uplink physical channel is transmitted in the grant free access, the UE ID for the downlink physical channel may be configured separately from the UE ID for the downlink physical channel. The higher layer processing unit 206 outputs the configuration information related to the UE ID to the transmitter 210/controller 208/receiver 204.

The higher layer processing unit 206 determines the coding rate, the modulation scheme (or MCS), the transmission power, and the like for the physical channels (physical downlink shared channel, physical uplink shared channel, and the like). The higher layer processing unit 206 outputs the coding rate/modulation scheme/transmission power to the transmitter 210/controller 208/receiver 204. The higher layer processing unit 206 can include the coding rate/modulation scheme/transmission power in higher layer signaling.

In a case that the downlink data to be transmitted is generated, the transmitter 210 transmits the physical downlink shared channel. In a case that the transmitter 210 is transmitting a resource for data transmission by use of the DL Grant, the transmitter 210 may transmit the physical downlink shared channel using the scheduled access, and transmit the physical downlink shared channel using the SPS in a case that the SPS is activated. The transmitter 210 generates the physical downlink shared channel and the demodulation reference signal/control signal associated with the physical downlink shared channel in accordance with the configuration related to the scheduled access/SPS input from the controller 208.

The coding unit 2100 codes the downlink data input from the higher layer processing unit 206 by using the coding scheme that is predetermined or configured by the controller 208 (the coding includes repetitions). The coding scheme may involve application of convolutional coding, turbo coding, Low Density Parity Check (LDPC) coding, Polar coding, and the like. The LDPC code may be used for data transmission, whereas the Polar code may be used for transmission of the control information. Different error correction coding may be used depending on the downlink channel to be used. Different error correction coding may be used depending on the size of the data or control information to be transmitted. For example, the convolution code may be used in a case that the data size is smaller than a prescribed value, and otherwise the correction coding described above may be used. For the coding described above, in addition to a coding rate of 1/3, a mother code such as a low coding rate of 1/6 or 1/12 may be used. In a case that a coding rate higher than the mother code is used, the coding rate used for data transmission may be achieved by rate matching (puncturing). The modulation unit 2102 modulates coded bits input from the coding unit 2100, in compliance with a modulation scheme notified by use of the downlink control information or a modulation scheme predetermined for each channel, such as BPSK, QPSK, 16QAM, 64QAM, or 256QAM (the modulation scheme may include 7/2 shift BPSK or 7/4 shift QPSK).

The multiple access processing unit 2106 performs signal conversion such that the base station apparatus 10 can achieve signal detection even in a case that multiple data are multiplexed on a sequence output from the modulation unit 2102 in accordance with multi-access signature resource input from the controller 208. In a case that the multi-access signature resource is configured as spreading, multiplication by the spreading code sequence is performed according to the configuration of the spreading code sequence. Note that, in a case that interleaving is configured as a multi-access signature resource in the multiple access processing unit 2106, the multiple access processing unit 2106 can be replaced with the interleaving unit. The interleaving unit performs interleaving processing on the sequence output from the modulation unit 2102 in accordance with the configuration of the interleaving pattern input from the controller 208. In a case that code spreading and interleaving are configured as a multi-access signature resource, the multiple access processing unit 2106 of the transmitter 210 performs spreading processing and interleaving. A similar operation is performed even in a case that any other multi-access signature resource is applied, and the sparse code or the like may be applied.

In a case that the OFDM signal waveform is used, the multiple access processing unit 2106 inputs the multiple-access-processed signal to the multiplexing unit 2108. The downlink reference signal generation unit 2112 generates a demodulation reference signal in accordance with the configuration information about the demodulation reference signal input from the controller 208. The configuration information about the demodulation reference signal/identification signal is used to generate a sequence acquired according to a rule predetermined in advance based on information such as the number of OFDM symbols notified by the base station apparatus by use of the downlink control information, the OFDM symbol position in which the DMRS is allocated, the cyclic shift, the time domain spreading, and the like.

The multiplexing unit 2108 multiplexes (maps, allocates) the downlink physical channel and the downlink reference signal to resource elements for each transmit antenna port. In a case that the SCMA is used, the multiplexing unit 2108 allocates the downlink physical channel to the resource elements in accordance with an SCMA resource pattern input from the controller 208.

The IFFT unit 2109 performs the Inverse Fast Fourier Transform (IFFT) on the multiplexed signal to perform OFDM modulation to generate OFDM symbols. The radio transmitting unit 2110 adds CPs to the OFDM-modulated symbols to generate a baseband digital signal. Furthermore, the radio transmitting unit 2110 converts the baseband digital signal into an analog signal, removes the excess frequency components from the analog signal, converts the signal into a carrier frequency by up-conversion, performs power amplification, and transmits the resultant signal to the terminal apparatus 20 via the transmit antenna 212. The radio transmitting unit 2110 includes a transmission power control function (transmission power controller). The transmission power control follows configuration information about the transmission power input from the controller 208. Note that, in a case that FBMC, UF-OFDM, or F-OFDM is applied, filtering is performed on the OFDM symbols in units of subcarriers or sub-bands.

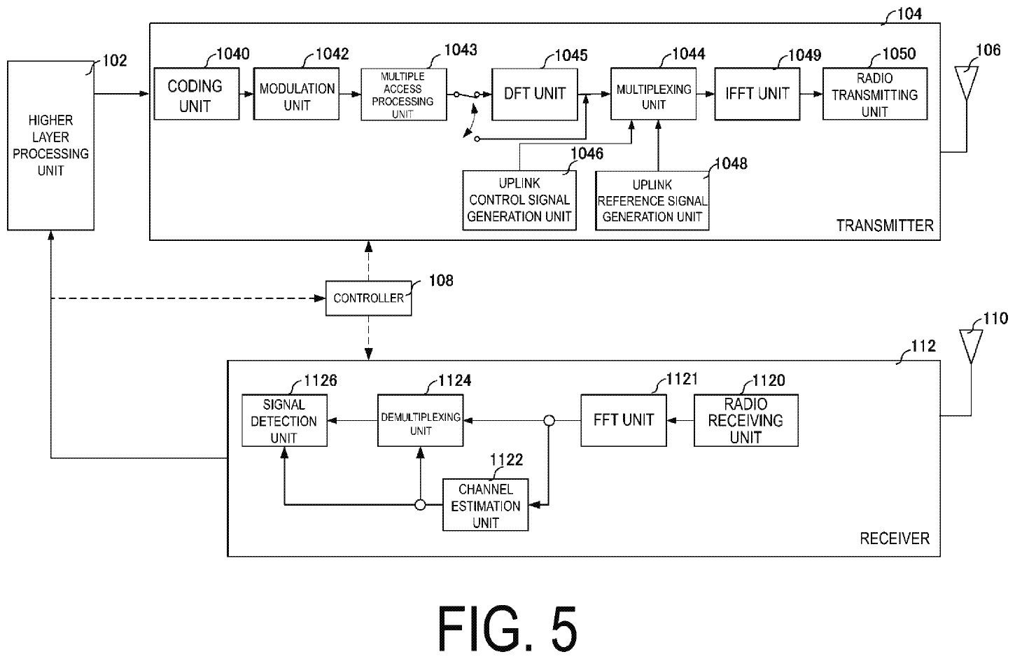

FIG. 5 is a schematic block diagram illustrating a configuration of the terminal apparatus 20 according to the present embodiment. The base station apparatus 10 includes a higher layer processing unit (higher layer processing step) 102, a transmitter (transmitting step) 104, a transmit antenna 106, a controller (control step) 108, a receive antenna 110, and a receiver (receiving step) 112. The transmitter 104 includes a coding unit (coding step) 1040, a modulation unit (modulating step) 1042, a multiple access processing unit (multiple access processing step) 1043, a multiplexing unit (multiplexing step) 1044, a DFT unit (DFT step) 1045, an uplink control signal generation unit (uplink control signal generating step) 1046, an uplink reference signal generation unit (uplink reference signal generating step) 1048, an IFFT unit 1049 (IFFT step), and a radio transmitting unit (radio transmitting step) 1050. The receiver 112 includes a radio receiving unit (radio receiving step) 1120, an FFT unit (FFT step) 1121, a channel estimation unit (channel estimating step) 1122, a demultiplexing unit (demultiplexing step) 1124, and a signal detection unit (signal detecting step) 1126.

The higher layer processing unit 102 performs processing of layers higher than the physical layer, such as the Medium Access Control (MAC) layer, the Packet Data Convergence Protocol (PDCP) layer, the Radio Link Control (RLC) layer, and the Radio Resource Control (RRC) layer. The higher layer processing unit 102 generates information needed to control the transmitter 104 and the receiver 112, and outputs the resultant information to the controller 108. The higher layer processing unit 102 outputs, to the transmitter 104, uplink data (e.g., UL-SCH), uplink control information, and the like.

The higher layer processing unit 102 receives information related to the terminal apparatus, such as the function of the terminal apparatus (UE capability), from the base station apparatus 10 (via the transmitter 104). The information related to the terminal apparatus includes information indicating that the grant free access is supported, information indicating whether the grant free access is supported on a function-by-function basis. The information indicating that the grant free access is supported and the information indicating whether the grant free access is supported on a function-by-function basis may be distinguished from each other based on the transmission mode.

Based on the various types of configuration information input from the higher layer processing unit 102, the controller 108 controls the transmitter 104 and the receiver 112. The controller 108 generates the uplink control information (UCI) based on the configuration information related to the control information input from the higher layer processing unit 102, and outputs the generated information to the transmitter 104.

The transmitter 104 codes and modulates the uplink control information, the uplink shared channel, and the like input from the higher layer processing unit 102 for each terminal apparatus, to generate a physical uplink control channel and a physical uplink shared channel. The coding unit 1040 codes the uplink control information and the uplink shared channel by using the predetermined coding scheme/coding scheme notified by use of the control information (the coding includes repetitions). The coding scheme may involve application of convolutional coding, turbo coding, Low Density Parity Check (LDPC) coding, Polar coding, and the like. The modulation unit 1042 modulates the coded bits input from the coding unit 1040 by using a predetermined modulation scheme/a modulation scheme notified by use of the control information, such as the BPSK, QPSK, 16QAM, 64QAM, or 256QAM.

The multiple access processing unit 1043 performs signal conversion such that the base station apparatus 10 can achieve signal detection even in a case that multiple data are multiplexed on a sequence output from the modulation unit 1042 in accordance with multi-access signature resource input from the controller 108. In a case that the multi-access signature resource is configured as spreading, multiplication by the spreading code sequence is performed according to the configuration of the spreading code sequence. The configuration of the spreading code sequence may be associated with other configurations of the grant free access such as the demodulation reference signal/identification signal. Note that the multiple access processing may be performed on the sequence after the DFT processing. Note that, in a case that interleaving is configured as a multi-access signature resource in the multiple access processing unit 1043, the multiple access processing unit 1043 can be replaced with the interleaving unit. The interleaving unit performs interleaving processing on the sequence output from the DFT unit in accordance with the configuration of the interleaving pattern input from the controller 108. In a case that code spreading and interleaving are configured as a multi-access signature resource, the multiple access processing unit 1043 of the transmitter 104 performs spreading processing and interleaving. A similar operation is performed even in a case that any other multi-access signature resource is applied, and the sparse code or the like may be applied.

The multiple access processing unit 1043 inputs the multiple-access-processed signal to the DFT unit 1045 or the multiplexing unit 1044 depending on whether a DFTS-OFDM signal waveform or an OFDM signal waveform is used. In a case that the DFTS-OFDM signal waveform is used, the DFT unit 1045 rearranges multiple-access-processed modulation symbols output from the multiple access processing unit 1043 in parallel and then performs Discrete Fourier Transform (DFT) processing on the rearranged modulation symbols. Here, a zero symbol sequence may be added to the modulation symbols, and the DFT may then be performed to provide a signal waveform in which, instead of a CP, a zero interval is used for a time signal resulting from IFFT. A specific sequence such as Gold sequence or a Zadoff-Chu sequence may be added to the modulation symbols, and the DFT may then be performed to provide a signal waveform in which, instead of a CP, a specific pattern is used for the time signal resulting from the IFFT. In a case that the OFDM signal waveform is used, the DFT is not applied, and thus the multiple-access-processed signal is input to the multiplexing unit 1044. The controller 108 performs control using a configuration of the zero symbol sequence (the number of bits in the symbol sequence and the like) and a configuration of the specific sequence (sequence seed, sequence length, and the like), the configurations being included in the configuration information related to the grant free access.

The uplink control signal generation unit 1046 adds the CRC to the uplink control information input from the controller 108, to generate a physical uplink control channel. The uplink reference signal generation unit 1048 generates an uplink reference signal.

The multiplexing unit 1044 maps each of the modulation symbols of the modulated uplink physical channels modulated by the multiple access processing unit 1043 and the DFT unit 1045, the physical uplink control channel, and the uplink reference signal to the resource elements. The multiplexing unit 1044 maps the physical uplink shared channel and the physical uplink control channel to resources allocated to each terminal apparatus.

The IFFT unit 1049 performs Inverse Fast Fourier Transform (IFFT) on the modulation symbols of each multiplexed uplink physical channel to generate OFDM symbols. The radio transmitting unit 1050 adds cyclic prefixes (CPs) to the OFDM symbols to generate a baseband digital signal. Furthermore, the radio transmitting unit 1050 converts the digital signal into an analog signal, removes excess frequency components from the analog signal by filtering, performs up-conversion to the carrier frequency, performs power amplification, and outputs the resultant signal to the transmit antenna 106 for transmission.

The receiver 112 uses the demodulation reference signal to detect the downlink physical channel transmitted from the base station apparatus 10. The receiver 112 detects the downlink physical channel based on the configuration information notified by the base station apparatus by use of the control information (such as DCI, RRC, SIB).

The radio receiving unit 1120 converts, by down-conversion, an uplink signal received through the receive antenna 110 into a baseband signal, removes unnecessary frequency components from the baseband signal, controls the amplification level in such a manner as to suitably maintain a signal level, orthogonally demodulates the signal based on an in-phase component and an orthogonal component of the received signal, and converts the resulting orthogonally-demodulated analog signal into a digital signal. The radio receiving unit 1120 removes a part corresponding to the CP from the converted digital signal. The FFT unit 1121 performs Fast Fourier Transform (FFT) on the signal from which the CPs have been removed, and extracts a signal in the frequency domain.

The channel estimation unit 1122 uses the demodulation reference signal to perform channel estimation for signal detection for the downlink physical channel. The channel estimation unit 1122 receives as inputs, from the controller 108, the resources to which the demodulation reference signal is mapped and the demodulation reference signal sequence allocated to each terminal apparatus. The channel estimation unit 1122 uses the demodulation reference signal sequence to measure the channel state between the base station apparatus 10 and the terminal apparatus 20. The demultiplexing unit 1124 extracts the signal in the frequency domain input from the radio receiving unit 1120 (the signal includes signals from multiple terminal apparatuses 20). The signal detection unit 1126 uses the channel estimation result and the signal in the frequency domain input from the demultiplexing unit 1124 to detect a signal of downlink data (uplink physical channel).

The higher layer processing unit 102 acquires the downlink data (bit sequence resulting from hard decision) from the signal detection unit 1126. The higher layer processing unit 102 performs descrambling (exclusive-OR operation) on the CRC included in the decoded downlink data for each terminal apparatus, by using the UE ID (RNTI) allocated to the terminal. In a case that no error is found in the downlink data as a result of the descrambling error detection, the higher layer processing unit 102 determines that the downlink data has been correctly received.

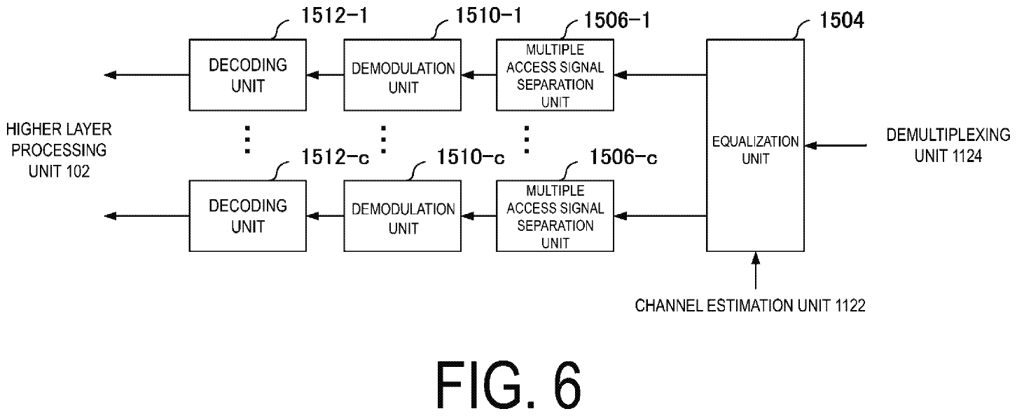

FIG. 6 is a diagram illustrating an example of the signal detection unit according to the present embodiment. The signal detection unit 1126 includes an equalization unit 1504, multiple access signal separation units 1506-1 to 1506-c, demodulation units 1510-1 to 1510-c, and decoding units 1512-1 to 1512-c.

The equalization unit 1504 generates an equalization weight based on the MMSE standard, from the frequency response input from the channel estimation unit 1122. Here, MRC and ZF may be used for the equalization processing. The equalization unit 1504 multiplies the equalization weight by the signal in the frequency domain input from the demultiplexing unit 1124, and extracts the signal in the frequency domain. The equalization unit 1504 outputs the equalized signal in the frequency domain to the multiple access signal separation units 1506-1 to 1506-c. c is a numeral of 1 or greater, and is a number of signals received in the same subframe, the same slot, or the same OFDM symbols, such as PUSCH and PUCCH. Reception of other downlink channels may be reception at the same timing.

Each of the multiple access signal separation units 1506-1 to 1506-c separates the signal multiplexed by the multi-access signature resource from the signal in the time domain (multiple access signal separation processing). For example, in a case that code spreading is used as a multi-access signature resource, each of the multiple access signal separation units 1506-1 to 1506-c performs inverse spreading processing using the used spreading code sequence. Note that, in a case that interleaving is applied as a multi-access signature resource, de-interleaving is performed on the signal in the time domain (de-interleaving unit).

The demodulation units 1510-1 to 1510-c receive as an input, from the controller 108, pre-notified or predetermined information about the modulation scheme. Based on the information about the modulation scheme, the demodulation units 1510-1 to 1510-c perform demodulation processing on a signal resulting from separating the multiple access signal, and outputs a Log Likelihood Ratio (LLR) of the bit sequence.

The decoding units 1512-1 to 1512-c receives as an input, from the controller 108, pre-notified or predetermined information about the coding rate. The decoding units 1512-1 to 1512-c perform decoding processing on the LLR sequences output from the demodulation units 1510-1 to 1510-c. In order to perform cancellation processing such as a Successive Interference Canceller (SIC) or turbo equalization, the decoding units 1512-1 to 1512-c may generate replicas from external LLRs or post LLRs output from the decoding units and perform the cancellation processing. A difference between the external LLR and the post LLR is whether to subtract, from the decoded LLR, the pre LLR input to each of the decoding units 1512-1 to 1512-c.

A transmission power control method for achieving high reliability in the present embodiment will be described. Uplink transmission power control of the related art is calculated by P_{PUSCH, f, c}(i, h, q_{d}, l)=min{P_{CMAX, f, c}(i), P_{O_PUSCH, f, c}(j)+10 log₁₀(2 μM_{PUSCH_RB, f, c}(i))+α_{f, c}(j)·PL_{f, c}(q_{d})+Δ_{TF, f, c}(i)+f_{f, c}(i, l)}. Here, min represents selection of a small value within { }. P_{CMAX, f c}(i) is an allowable maximum transmission power of the terminal apparatus for carrier f of serving cell c in the i-th subframe, and P_{O_PUSCH, f, c}(j) is a nominal target received power configured through higher layer (RRC) for carrier f of serving cell c in scheduling j per RB, j is a value dependent on a type of scheduling or a transmission signal, where multiple values for j are configured through higher layer (RRC) such as j=0 for RACH, j=1 for a SPS/grant free access, and j=2 to j−1 for dynamic scheduling, and then, are designated in the DCI (e.g., the SRS Resource Indicator (SRI) field), α_{f, c}(j) is a parameter for the fractional transmission power control for carrier f of serving cell c, PL_{f, c}(q_{d}) is a path loss of serving cell c in resource q_{d} for a path loss measurement reference signal, Δ_{TF, f, c}(i) is a parameter by a modulation order for carrier f of serving cell c in the i-th subframe, f_{f, c}(i, l) is a parameter notified from the base station apparatus to the terminal apparatus to perform closed loop control for carrier f of serving cell c, and l is a variable for enabling multiple closed loop controls. For example, l=1 is usually given, and in a case that l={1, 2} is configured through higher layer (RRC), a TPC command of one of l=1 or l=2 is transmitted, the TPC command can be reflected to only one of them. Use of l=1 and l=2 may be differently used by configuring the value of l used for the SPS/grant free access to use the other for dynamic scheduling. P_{O_PUSCH, f, c}(j) used to calculate the transmission power is determined by the sum of P_{O_NOMINAL_PUSCH, f, c}(j) and P_{O_UE_PUSCH, f, c}(j). A value of P_{O_NOMINAL_PUSCH, f, c}(j) is determined by the sum of the P_{O_PRE} notified through higher layer (RRC) and Δ_{PREAMBLE_Msg3} in a case of j=0, and configured through higher layer (RRC) in a case of j=1 or 2, where multiple values for SPS/grant free access and dynamic scheduling are configured for each case. A value of P_{O_UE_PUSCH, c}(j) is 0 in a case that j=0, and notified through higher layer (RRC) in a case of j=1 or 2, where multiple values for SPS/grant free access and dynamic scheduling are configured for each case.

A value of P_{CMAX, f, c}(i) is configured to be between P_{CMAX_L,c}(i) and P_{CMAX_H, c}(i) according to a capability of a Power Amplifier (PA) of the terminal apparatus, P_{CMAX_L,c}(i) being determined from Maximum Power Reduction (MPR), Additional-MPR (A-MPR), and Power Management-MPR (P-MPR), P_{CMAX_H, c}(i) being determined from P_{EMAX, c} and P_{PowerClass}.

In the related art, only the target received power P_{O_PUSCH, f, c}(j) and the parameter for the fractional transmission power control α_{f, c}(j) dependent on the type of scheduling can be designated in the DCI and dynamically changed. In a case that which of the multiple target received powers P_{O_PUSCH, f, c}(j) is used in the dynamic scheduling is designated by the SRI in the DCI, dynamic switching cannot be performed because fallback DCI format 00 includes no SRI field. DCI format 0_1 supports multi-antenna transmission and includes the SRI field, but the number of bits constituting the DCI format (payload size) is large. In LTE and NR, the DCI format places the DCI format on a predetermined resource element (search space), and thus, in a case that the number of resource elements is constant, the coding rate for transmitting the DCI format with a large payload size is higher compared to the DCI format with a smaller payload size, making it difficult to satisfy the high reliability. The data for which high reliability is required and the data that needs high reliability exist even in the dynamic scheduling, and reliability required for the data may be different even in the SPS/grant free access as well. Therefore, the high reliability of the DCI format and the reliability required for the data are satisfied while the transmission power control matching the reliability is dynamically switched.

First, DCI format 0_0 for uplink fallback is used to switch the transmission power control matching the reliability. The terminal apparatus 20 receives a transmission parameter set matching the reliability of data transmitted through a layer higher signaling (e.g., RRC signaling) from than the base station apparatus 10 (RRC setup). The transmission parameter set may include at least one of a H-RNTI used to mask the CRC for blind decoding of DCI format 0_0, a target received power, parameters for a fractional TPC, indication of a path loss to be used, and an index l of closed loop control to be used (where l may be either 1 or 2, or a value of 0 or 3 or more may be added). The transmission parameter set may include a combination of the configured indices (j, q_{d}, l), or may be configured with new target received power, parameters of fractional TPC, indication of a path loss to be used, and an index of closed loop control to be used. Note that the term Q_{f, c}(r) that matches the reliability of the data (a term configured by a QoS or a QoS Class Indicator (QCI) of the data to be transmitted) may be added as the uplink transmission power control, like P_{PUSCH, f, c}(i, j, q_{d}, l)=min{P_{CMAX, f, c}(i), P_{O_PUSCH, f c}(j)+10 log₁₀(2 μM_{PUSCH_RB, f, c}(i))+α_{f, c}(j)·PL_{f, c}(q_{d})+Δ_{TF, f, c}(i)+Q_{f, c}(r)+f_{f, c}(i, l)}, and Q_{f, c}(r) may be included in the transmission parameter set.

The terminal apparatus 20 performs the blind decoding on the search space (Common Search Space (CSS) or UE-specific SS (USS)) to switch the transmission power control between a case of detecting DCI format 0_0 with the H-RNTI, and a case of detecting DCI format 0_0 with the C-RNTI or CS-RNTI. The transmission power control of the related art is applied in the case of detecting DCI format 0_0 with the C-RNTI or CS-RNTI, and the transmission power control for transmission of high reliable data is applied in the case of detecting DCI format 0_0 with the H-RNTI. For example, in the case of detecting DCI format 00 with the H-RNTI, the target received power, the parameters of fractional TPC, the indication of a path loss to be used, the index l of the closed loop control to be used, and the like which are notified as the transmission parameter set may be applied, or Q_{f, c}(r) matching the reliability of the data may be configured to a value equal to or greater than 0 (a value notified by the higher layer). In another example, in a case that carrier aggregation is applied, a minimum guaranteed power may be configured for a case that the maximum transmission power P_{CMAX, f, c}(i) is exceeded during simultaneous transmission of the multiple pieces of uplink data (PUSCH) or PUSCH and PUCCH in the same slot and/or in the same OFDM symbol. In the related art, in the case that the maximum transmission power is exceeded during the simultaneous transmission of the multiple PUSCHs, the scaling that distributes the transmission power uniformly from the maximum transmission power P_{CMAX, f, c}(i) is applied. On the other hand, in the case that the maximum transmission power is exceeded during the simultaneous transmission of PUSCH and the PUCCH in the related art, a transmission power obtained by subtracting the PUCCH from the maximum transmission power is allocated to the PUCSH. Therefore, in the transmission of data for which high reliability is required, the minimum guaranteed power is ensured even in a case that the maximum transmission power is exceeded as described above, and therefore, the reliability cannot be reduced. In a specific example, βP_{PUSCH, f, c}(i, j, q_{d}, l) obtained by multiplying the transmission power values P_{PUSCH, f, c}(i, j, q_{d}, l) for the high reliable data transmission by a minimum compensation coefficient β (a value equal to or greater than 0 and less than or equal to 1, notified by the higher layer (RRC)) is set as the minimum guaranteed power, and the like. In yet another example, some of the parameters (the transmission parameter set described above) used for calculating the transmission power control value of the high reliable data transmission may be multiplied by a correction term β, where the target received power for the high reliable data transmission is multiplied by β to obtain a transmission power value min{P_{CMAX, f, c}(i), βP_{O_PUSCH, f, c}(j)+10 log₁₀(2 μM_{PUSCH_RB, f, c}(i))+α_{f, c}(j)·PL_{f, c}(q_{d})+Δ_{TF, f, c}(i)+f_{f, c}(i)}. Another term included in the transmission parameter set may be multiplied by the correction term β. Accordingly, in the case of detecting DCI format 0_0 with the H-RNTI, and further in the case that the maximum transmission power is exceeded during the simultaneous transmission of the multiple pieces of PUSCHs or the PUSCH and PUCCH in the same slot and/or in the same OFDM symbol, the minimum guaranteed power may be allocated to the data for which high reliability is required, and the remainder may be allocated to the PUSCH or PUCCH to be simultaneously transmitted. Note that Dual Connectivity may or may not be applied in carrier aggregation. In a case that Dual Connectivity is applied, the transmission power control described above may be performed in accordance with the reliability required for the data in the PCell and the SCell in the MCG, or may be applied to the PSCell and the SCell in the SCG, and the minimum guaranteed power may be allocated to the data for which high reliability is required before the power distribution for the MCG and the SCG, and the remaining transmission power may be distributed to other signals of the MCG and SCG. Note that the above may be applied to simultaneous transmission of the PUSCH and the SRS. Note that in a case that the transmission power obtained by subtracting the minimum guaranteed power from the maximum transmission power is notified in advance (e.g., RRC) or is below a predetermined threshold value, transmission may not be performed depending on the type of signal. For example, the PUSCH and the SRS are not transmitted, and the PUCCH is always transmitted regardless of the transmission power which can be allocated.

Even in the transmission of data for which high reliability is required in the SUL, the transmission power control may be switched depending on whether DCI format 0_0 is detected with the H-RNTI or DCI format 0_0 is detected with the C-RNTI or the CS-RNTI. Since the SUL is used to ensure an uplink coverage, a frequency lower than the frequency of a non-SUL serving cell is configured. In other words, the path loss of a SUL serving cell is lower relative to a non-SUL serving cell. Because the SUL is for a cell of only an uplink, the path loss cannot be measured by the downlink signal, so the transmission power control is performed with the path loss being corrected from the non-SUL serving cell. For example, in the case of detecting DCI format 0_0 with the H-RNTI, and a case that the DCI format indicates a SUL scheduling, calculation is made by P_{PUSCH, f, c}(i, j, q_{d}, l)=min{P_{CMAX, f, c}(i), P_{O_PUSCH, f, c}(j)+10 log₁₀(2 μM_{PUSCH_RB, f, c}(i))+α_{f, c}(j)·PL_{f, c}(q_{d})−PL_{SUL}+Δ_{TF, f, c}(i)+f_{f, c}(i, l)}. Here, PL_{SUL} is a term that corrects the path loss of the non-SUL serving cell into the path loss of the SUL, and is set to 0 or greater. However, the transmission power value obtained by PL_{SUL}=0 means the transmission power value of the non-SUL serving cell. In the case of detecting DCI format 00 with the H-RNTI, the path loss may not be corrected with PL_{SUL}=0.

Note that the present embodiment is described for DCI format 0_0, but may be applied to DCI format 0_1. Note that the present embodiment may be limitedly applied to DCI format 0_0 and may not be applied to DCI format 0_1.

Note that multiple H-RNTIs may be provided and each may be notified of the parameter set. For example, the H-RNTI may be configured for high reliable dynamic scheduling and for high reliable SPS/grant free access. Multiple reliability levels may be provided and the H-RNTI may be configured for each reliability level.

In the present embodiment, the transmission power control is dynamically switched by adding the RNTI used for detection of the DCI format as the transmission power control for achieving high reliability. As a result, reliability in one transmission of transport block can be increased, and low latency and high reliability can be achieved.

### Second Embodiment

The present embodiment is another example of dynamically switching the transmission power control in order to achieve high reliability. The communication system according to the present embodiment includes the base station apparatus 10 and the terminal apparatus 20 illustrated in FIG. 3, FIG. 4, FIG. 5, and FIG. 6. Differences/additional points different from the first embodiment will be mainly described below.

In the previous embodiment, the transmission power control is dynamically switched depending on the type of RNTI used for detection of the DCI format (uplink grant) with blind decoding. In the present embodiment, an example of dynamically switching the transmission power control depending on different conditions will be described. The terminal apparatus 20 receives a transmission parameter set matching the reliability of data transmitted through a layer higher signaling (e.g., RRC signaling) from than the base station apparatus 10 (RRC setup). The transmission parameter set may include at least one of a dynamic transmission power control switching indicator, a target received power, parameters for a fractional TPC, indication of a path loss to be used, and an index l of closed loop control to be used (where l may be either 1 or 2, or a value of 0 or 3 or more may be added). Note that the term Q_{f, c}(r) that matches the reliability of the data (a term configured by a QoS or a QoS Class Indicator (QCI) of the data to be transmitted) may be added as the uplink transmission power control, like P_{PUSCH, f, c}(i, j, q_{d}, l) min{P_{CMAX, f, c}(i), P_{O_PUSCH, f, c}(j)+10 log₁₀(2 μM_{PUSCH_RB, f, c}( ))+α_{f, c}(j)·PL_{f, c}(q_{d})+Δ_{TF, f, c}(i)+Q_{f, c}(r)+f_{f, c}(i, l)}, and Q_{f, c}(r) may be included in the transmission parameter set.

Here, the dynamic transmission power control switching indicator uses a transmission parameter set for data for which high reliability is required, in a case that a parameter notified by the DCI (uplink grant) from the base station apparatus 10, in other words, the field included in the DCI format satisfies a prescribed condition. The prescribed condition may be a case that the configuration of the blind decoding of the DCI format (referred to herein as DCI format 0_2) having a payload size smaller than DCI format 00 is set up through RRC, and DCI format 0_2 is detected. DCI format 0_2 may have only some fields of DCI format 0_0, for example, may have only the time domain resource assignment, the MCS, the NDI, and the RV. Note that the present invention is not limited to this example, and DCI format 02 may include a field of SRI.

An example of a prescribed condition of the dynamic transmission power control switching indicator may be a case that the configuration of a portion of the search space for detecting the DCI format is set up through RRC, and the DCI format is detected under the configured conditions. Specifically, the condition example includes indicating either the CSS or the USS, indicating a prescribed aggregation level (aggregation level 4 or higher, or 8 or higher), and the like. This means that a limitation is put on a case that the uplink grant is transmitted at a low coding rate by indicating a high aggregation level, and it is possible to satisfy the high reliability of the PDCCH uplink grant and the PUSCH data.

An example of a prescribed condition of the dynamic transmission power control switching indicator may be a case that the configuration of the time domain resource assignment notified by use of the DCI format is set up through RRC, and the DCI format under the configured conditions is detected. Specifically, the condition example includes a case that the number of OFDM symbols used for transmission of data included in the time domain resource assignment is equal to or less than a prescribed value, a case that the value K₂ from the slot receiving the DCI format to the slot transmitting the PUSCH is equal to or less than a prescribed value, and the like. Note that the number of OFDM symbols set up through RRC may be the number of OFDM symbols excluding or including OFDM symbols for the DMRS. In order to realize a low latency in addition to high reliability by the URLLC, the prescribed condition may be a case of the data transmission in units of mini-slot (non-slot basis, where only a portion of OFDM symbols included in the slot is used) not in units of slot unit. Similarly, a smaller value is indicated to the value K₂ from the slot receiving the DCI format to the slot transmitting the PUSCH in a case of data for which low latency is required, and thus, K₂ may be a prescribed condition.

Note that, in the previous embodiment and the present embodiment, multiple examples are described as the method for dynamically switching the transmission power control, but in a case that an MCS table for transmission of the data for which high reliability is required (a URLLC MCS table) and an MCS table for transmission of the data for which high reliability is not required are present, any method described in the previous embodiment and the present embodiment may be used to dynamically switch to the URLLC MCS table.

Note that, in the previous embodiment and the present embodiment, multiple examples are described as the method for dynamically switching the transmission power control, but in a case that a CQI table for transmission of the data for which high reliability is required (a URLLC CQI table) and a CQI table for transmission of the data for which high reliability is not required are present, any method described in the previous embodiment and the present embodiment may be used to dynamically switch to the URLLC CQI table in a case of receiving a trigger of a CQI reporting.

Note that, in the previous embodiment and the present embodiment, multiple examples are described as the method for dynamically switching the transmission power control, but in a case that an error correction coding for transmission of the data for which high reliability is required (a URLLC error correction coding) and an error correction coding for transmission of the data for which high reliability is not required are present, any method described in the previous embodiment and the present embodiment may be used to dynamically switch to the URLLC error correction coding.

Note that, in the previous embodiment and the present embodiment, multiple examples are described as the method for dynamically switching the transmission power control, but in a case that a PH reporting for transmission of the data for which high reliability is required (a URLLC PH reporting) and a PH reporting for transmission of the data for which high reliability is not required are present, any method described in the previous embodiment and the present embodiment may be used to dynamically switch to the URLLC PH reporting.

Note that, in the previous embodiment and the present embodiment, multiple examples are described as the method for dynamically switching the transmission power control, but in a case that an SRS transmission mode/SRS transmission power control for transmission of the data for which high reliability is required (a URLLC SRS transmission) and an SRS transmission mode/SRS transmission power control for transmission of the data for which high reliability is not required are present, any method described in the previous embodiment and the present embodiment may be used to dynamically switch to the URLLC SRS transmission in a case of receiving a trigger of SRS transmission.

Note that, in the previous embodiment and the present embodiment, multiple examples are described as the method for dynamically switching the transmission power control, but in a case that a PUCCH transmission mode/PUCCH transmission power control for transmission of the data for which high reliability is required (a URLLC PUCCH transmission) and a PUCCH transmission mode/PUCCH transmission power control for transmission of the data for which high reliability is not required are present, any method described in the previous embodiment and the present embodiment may be used to dynamically switch to the URLLC PUCCH transmission in a case of receiving the downlink data on the PDSCH.

In the present embodiment, the transmission power control is dynamically switched in a case that the DCI format is detected, or the field included in the DCI satisfies a prescribed condition, as the transmission power control for achieving high reliability. As a result, reliability in one transmission of transport block can be increased, and low latency and high reliability can be achieved.

### Third Embodiment

The present embodiment is an example of dynamically switching the transmission power control in SPS Type 2 in order to achieve high reliability. The communication system according to the present embodiment includes the base station apparatus 10 and the terminal apparatus 20 illustrated in FIG. 3, FIG. 4, FIG. 5, and FIG. 6. Differences/additional points different from the first embodiment will be mainly described below.

In SPS Type 2 (type 2 configured grant transmission, UL-TWG-type2), the base station apparatus 10 transmits transmission parameters for the SPS/grant free access to the terminal apparatus 20 through higher layer signaling (e.g., RRC), and transmits start of grant (activation) and end of grant (deactivation/release) of the data transmission in the SPS/grant free access, and change of the transmission parameters through DCI (L1 signaling). In a case that the transmission allowance or the end of grant is notified by use of the DCI, some fields of the DCI format are used to perform Validation by the terminal apparatus 20 for checking whether the notification of the transmission allowance or end of grant in the SPS is correct. For example, in the transmission allowance in the SPS, the NDI, the RV, the HARQ process number, the highest order bit of the MCS, and the TPC command in the DCI format are used for the Validation, and in the end of grant in the SPS, the resource assignment in the time domain and the frequency domain is used for the Validation in addition to the fields used for transmission allowance. In a case that the DCI format for a multi-antenna (DCI format 0_1) is used, information on the antenna port to be used, information on the DMRS, and the SRI may be used. In the present invention, the fields used in the Validation are not limited to this example, but a case of the above-described example in DCI format 0_0 will be described below.

As an example of the present embodiment, the NDI, the RV, the HARQ process number, the most significant bit of the MCS, and the TPC command in the DCI for the transmission allowance in the SPS transmitted by the base station apparatus 10 are set to 0, and the NDI, the RV, the HARQ process number, the all bits of the MCS, the TPC command, the resource assignment in the time domain and the frequency domain in the DCI for the end of grant in the SPS are set to 1. The terminal apparatus 20 performs the Validation by confirming that the DCI detected with the CS-RNTI is the above-described configuration.

The terminal apparatus 20 receives a transmission parameter set matching the reliability of data transmitted through a layer higher signaling (e.g., RRC signaling) from than the base station apparatus 10 (RRC setup). The transmission parameter set may include at least one of a dynamic transmission power control switching indicator, a target received power, parameters for a fractional TPC, indication of a path loss to be used, and an index l of closed loop control to be used (where l may be either 1 or 2, or a value of 0 or 3 or more may be added). Note that the term Q_{f, c}(r) that matches the reliability of the data (a term configured by a QoS or a QoS Class Indicator (QCI) of the data to be transmitted) may be added as the uplink transmission power control, like P_{PUSCH, f, c}(i, j, q_{d}, l)=min{P_{CMAX, f, c}(i), P_{O_PUSCH, f, c}(j)+10 log₁₀(2 μM_{PUSCH_RB, f, c}(i)+α_{f, c}(j)·PL_{f, c}(q_{d})+Δ_{TF, f, c}(i)+Q_{f, c}(r)+f_{f, c}(i, l)}, and Q_{f, c}(r) may be included in the transmission parameter set.

In the present embodiment, in a case that the transmission allowance of SPS Type 2 is notified for the transmission of data for which high reliability is required by use of the DCI, the transmission allowance and end of grant of SPS Type 2 described above are set to a value different from the DCI Validation. For example, in the transmission allowance of SPS Type 2 for the transmission of data for which high reliability is required by use of the DCI, the prescribed number of bits for each field may be extracted from the left of a sequence of 01010101 . . . and assigned to the NDI, the RV, the HARQ process number, the most significant bit of the MCS, and the TPC command from the most significant bit. For example, the NDI is assigned with “0” in a case of 1 bit NDI, the RV is assigned with “01” in a case of 2 bit RV, and the HARQ process number is assigned with “0101”. However, the present invention is not limited to the present embodiment, and the extracted sequence may be assigned to each field from the least significant bit.

In a case that the terminal apparatus 20 receives the transmission allowance of SPS Type 2 for the transmission of data for which high reliability is required in the above-described manner, the terminal apparatus 20 may perform data transmission using the transmission parameter set described above, and achieve reliability. The above-described transmission parameter set may include the MCS table for transmission of the data for which high reliability is required (URLLC MCS table), the CQI table for transmission of the data for which high reliability is required (URLLC CQI table), the error correction coding for transmission of the data for which high reliability is required (URLLC error correction coding), the PH reporting for transmission of the data for which high reliability is required (URLLC PH reporting), and the SRS transmission mode/SRS transmission power control for transmission of the data for which high reliability is required (URLLC SRS transmission). Note that, in a case that the downlink SPS transmission allowance is received for downlink data reception for which high reliability is required in the above-described method, data reception using the above-described transmission parameter set and PUCCH transmission in the PUCCH transmission mode/PUCCH transmission power control (PUCCH transmission for URLLC) for transmitting ACK/NACK for the downlink data may be performed to achieve high reliability.

Note that the PUCCH transmission power control is calculated by P_{PUCCH, f, c}(i, qᵤ, q_{d}, l)=min{P_{CMAX, f, c}(i), P_{O_PUCCH, f, c}(qᵤ)+PL_{f, c}(q_{d})+Δ_{F_PUCCH}(F)+Δ_{TF, f, c}(qᵤ)+g_{f, c}(i, l)}. Here, min represents selection of a small value within { }. P_{CMAX, f, c}(i) is an allowable maximum transmission power of the terminal apparatus for carrier f of serving cell c in the i-th subframe, and P_{O_PUCCH, f, c}(qᵤ) is a nominal target received power configured through higher layer (RRC) for carrier f of serving cell c in scheduling j per RB, qᵤ depends on reference signal resource sets multiple number of which are configured through higher layer (RRC) for dynamic scheduling, PL_{f, c}(q_{d}) is a path loss of serving cell c in resource q_{d} for a path loss measurement reference signal, Δ_{F_PUCCH}(F) is a value depending on a PUCCH format configured through higher layer (RRC), Δ_{TF, f, c}(i) is a parameter by a modulation order for carrier f of serving cell c in the i-th subframe, g_{f, c}(i, l) is a parameter notified from the base station apparatus to the terminal apparatus to perform closed loop control for carrier f of serving cell c, and l is a variable for enabling multiple closed loop controls. For example, l=1 is usually given, and in a case that l={1, 2} is configured through higher layer (RRC), a TPC command of one of l=1 or l=2 is transmitted, the TPC command can be reflected to only one of them. Use of l=1 and l=2 may be differently used by configuring the value of l used for the downlink SPS to use the other for downlink dynamic scheduling. In the PUCCH transmission including the ACK/NACK for the high reliable downlink data transmission, at least one of the target received power, the indication of a path loss to be used, Δ_{F_PUCCH}(F), the index l of the closed loop control to be used (where l may be either 1 or 2, or value of 0 or 3 or more may be added) may be changed to a parameter for high reliability. Note that in a case that carrier aggregation is applied or Dual Connectivity is applied with respect to the PUCCH transmission power control for which high reliability is required, the similar operations as those described in the first embodiment may be used.

Note that the method of the first embodiment or the second embodiment may be configured as mode 1 for transmission of data for which high reliability is required and the method of the third embodiment may be configured as mode 2 for transmission of data for which high reliability is required to use any of both transmission modes. For example, the terminal apparatus 20 may notify of supporting any transmission mode in a supporting function (UE capability) of the terminal apparatus, and the base station apparatus 10 may send, based on the notification, a transmission allowance in any transmission mode by use of the DCI for each terminal apparatus 20.

In the present embodiment, as the transmission power control for achieving high reliability, the transmission power control is dynamically switched in a case of the pattern described above in the fields used in the Validation in the DCI of SPS type2. As a result, reliability in one transmission of transport block can be increased, and low latency and high reliability can be achieved.

### Fourth Embodiment

The present embodiment describes an example of the transmission power control in the BWP. The communication system according to the present embodiment includes the base station apparatus 10 and the terminal apparatus 20 illustrated in FIG. 3, FIG. 4, FIG. 5, and FIG. 6. Differences/additional points different from the first embodiment will be mainly described below.

NR supports higher frequencies, and thus the bandwidth of one serving cell (component carrier (cc)) is wider than that in LTE (maximum 20 MHz). Therefore, in order to suppress the power consumption of the terminal apparatus 20, in a case of large amount of data transmission, the bandwidth (the number of RBs) used in the one serving cell may be widened (bandwidth available for data transmission/reception), and otherwise the bandwidth used may be narrowed. The terminal apparatus 20 may receive from the base station apparatus 10 and use a default BWP to be used in a case of being connected to the serving cell, and a configuration of the BWP to be used as indicated by the control information. Note that the BWP to be used as indicated by the control information may be switched to the default BWP in a case that a timer is configured and no transmission/reception is performed while the timer is valid (PDSCH/PDCCH (detecting the DCI addressed to the terminal apparatus itself)/PUSCH/PUCCH (in a case of receiving UL Grant in a case of SR)). Four BWPs may be configured for one serving cell, where a first BWP may include all RBs available for one serving cell, a second BWP may include half the number of RBs available for one serving cell, a third BWP may include ¼ of the number of available RBs, and a fourth BWP may include 1/20 of the number of available RBs. The all BWPs may include a common RB, or some BWPs may not include the common RB. The downlink BWP may be necessarily configured with a synchronization signal or a broadcast channel, and all of the BMPs may include the common RB. In one serving cell, the number of activatable BWPs may be one.

Here, in the case that the BWP include only some of the RBs available in the serving cell, there are a case that an RB at the end of the serving cell is activated and a case that an RB in the center of the serving cell is activated. In the present embodiment, an example of switching the transmission power control by the BWP activated in this manner will be described.

The P_{CMAX_L, c}(i) used by the terminal apparatus 20 in determining P_{CMAX, f, c}(i) is determined from MPR, A-MPR, and P-MPR. The MPR depends on a bandwidth of one serving cell, a bandwidth used for uplink data transmission (the number of RBs), and a modulation scheme (modulation order). The A-MPR is calculated by a calculation formula depending on a Network Signalling Value (NS value) which is notified from the network, in order to satisfy the demand for additional Adjacent Channel Leak Ratio (ACLR) and spectral emission. For example, the A-MPR is calculated based on the bandwidth of the serving cell and the number of resource blocks used for data transmission in a case of NS_03, or is calculated depending on an E-UTRA Band in addition to the condition of NS_03 in a case of NS_05. In a case of NS_07 and NS_10, the A-MPR is calculated by the minimum value of the index of the resource block (the resource block to be transmitted) used for data transmission and the number of RBs. In a case of NS_15, the A-MPR is calculated by the maximum value of the index of the resource block (the resource block to be transmitted) used for data transmission and the number of RBs. The P-MPR is a value configured to comply with legislation.

In NR, a study is underway to achieve the data transmission in units of mini-slot (non-slot bases, using only some of OFDM symbols included in the slot), and UL Grant, data transmission, and ACK/NACK in 1 msec in a Self-Contained manner. Therefore, the number and position of RBs used for data transmission vary at an interval shorter than LTE, and the time that can be used in calculating the MPR and the A-MPR is limited. Therefore, the MPR of the present embodiment uses the number of RBs in the activated BWP rather than the number of RBs used for data transmission. In addition, the A-MPR in the present embodiment uses the number of RBs in the activated BWP rather than the number of RBs used for data transmission, and uses the minimum/maximum index of the RB in the activated BWP rather than the minimum/maximum index of RBs used for data transmission. That is, it is meant to use the minimum/maximum index of the RBs in the activated BWP within the all RBs in the serving cell.

The MPR of the present embodiment is calculated using the number of RBs in the activated BWP, the bandwidth of the serving cell, and the modulation scheme. Therefore, the MPR can be calculated without depending on the number of RBs used for data transmission notified by use of the DCI. This method of calculating the MPR may be applied to the case that the activated BWP include only some of the RBs available in the serving cell. This method of calculating the MPR may be applied to only a case of being configured (set up) through higher layer (e.g., RRC). Whether to apply this method of calculating the MPR may depend on a waveform, and this method may be applied only at the time of OFDM.

The A-MPR in the present embodiment is calculated using the number of RBs in the activated BWP, the bandwidth of the serving cell, and the minimum/maximum index of the activated BWP of the indexes of the RBs available in the serving cell. Therefore, the A-MPR can be calculated without depending on the minimum/maximum index of the RBs used for data transmission notified by use of the DCI. This method of calculating the A-MPR may be applied to the case that the activated BWP include only some of the RBs available in the serving cell. This method of calculating the A-MPR may be applied to only a case of being configured (set up) through higher layer (e.g., RRC). Whether to apply this method of calculating the A-MPR may depend on a waveform, and this method may be applied only at the time of OFDM. The A-MPR in the present embodiment may be calculated using min{N_{RB}−Ne, NS}, where Ns is the smallest index of the activated BWP of the indexes of the RBs available in the serving cell and Ne is the maximum index. Note that N_{R} is the number of all RBs in the serving cell.

In the present embodiment, the transmission power control is switched depending on the activated BWP. As a result, the MPR and the A-MPR can be easy to calculate.

### Fifth Embodiment

The present embodiment describes an example in which the terminal apparatus performs uplink Pre-emption for a resource of the eMBB to perform URLLC data transmission in a case that a URLLC packet arrives in data transmission of the eMBB. The communication system according to the present embodiment includes the base station apparatus 10 and the terminal apparatus 20 illustrated in FIG. 3, FIG. 4, FIG. 5, and FIG. 6. Differences/additional points different from the first embodiment will be mainly described below.

In one example of the present embodiment, the terminal apparatus 20 receives the configuration of the uplink Pre-emption by use of the higher layer control information. Here, the configuration of the uplink Pre-emption may include the position and the number of RBs on which Pre-emption is performed.

The base station apparatus 10 notifies the terminal apparatus 20 of the position and the number of relative RBs used for the uplink Pre-emption among the RBs used for non-URLLC uplink data transmission. For example, assume that a starting position and the number of RBs used for the non-URLLC uplink data transmission are Mₛₜₐᵣₜ and M_{RB}, respectively, and the position and the number of relative RBs used for the URLLC uplink data transmission Pre-emption are N_{offset} and N_{BW}, respectively.

First, in a case of M_{RB}≥N_{B}w, the RBs where the URLLC data is allocated may be determined by Nₛₜₐᵣₜ=Mₛₜₐᵣₜ+N_{offset}. An end position of the RBs where the URLLC data is allocated may be determined by min{Mₛₜₐᵣₜ+M_{RB}, Nₛₜₐᵣₜ+N_{RB}}. In another example, the starting position of RBs where the URLLC data is allocated may be determined by Nₛₜₐᵣₜ=N_{end}−N_{BW}. Next, in the case of M_{RB}<N_{BW}, the RBs where the URLLC data is allocated may be all RBs of MB.

Multiplexing with the non-URLLC data in the terminal apparatus 20 may not be performed depending on the waveform. For example, in the case of OFDM, the non-URLLC data and the URLLC data are multiplexed. On the other hand, in the case of DFT-S-OFDM, the non-URLLC data and the URLLC data are not multiplexed.

In the present embodiment, in a case that the URLLC packet occurs during the transmission of the eMBB data, the terminal apparatus can transmit at the same time.

Note that the embodiments herein may be applied in combination with multiple embodiments, or each embodiment only may be applied.

A program running on an apparatus according to the present invention may serve as a program that controls a Central Processing Unit (CPU) and the like to cause a computer to operate in such a manner as to realize the functions of the above-described embodiment according to the present invention. Programs or the information handled by the programs are temporarily read into a volatile memory, such as a Random Access Memory (RAM) while being processed, or stored in a non-volatile memory, such as a flash memory, or a Hard Disk Drive (HDD), and then read by the CPU to be modified or rewritten, as necessary.

Note that the apparatuses in the above-described embodiments may be partially enabled by a computer. In that case, a program for realizing the functions of the embodiments may be recorded on a computer readable recording medium. This configuration may be realized by causing a computer system to read the program recorded on the recording medium for execution. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, and the like.

Moreover, the “computer-readable recording medium” may include a medium that dynamically retains a program for a short period of time, such as a communication line that is used for transmission of the program over a network such as the Internet or over a communication line such as a telephone line, and may also include a medium that retains a program for a fixed period of time, such as a volatile memory within the computer system for functioning as a server or a client in such a case. Furthermore, the above-described program may be one for realizing some of the above-described functions, and also may be one capable of realizing the above-described functions in combination with a program already recorded in a computer system.

Furthermore, each functional block or various characteristics of the apparatuses used in the above-described embodiments may be implemented or performed on an electric circuit, that is, typically an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor or may be a processor of known type, a controller, a micro-controller, or a state machine instead. The above-mentioned electric circuit may include a digital circuit, or may include an analog circuit. Furthermore, in a case that with advances in semiconductor technology, a circuit integration technology appears that replaces the present integrated circuits, it is also possible to use an integrated circuit based on the technology.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Various modifications are possible within the scope of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

### INDUSTRIAL APPLICABILITY

An aspect of the present invention can be preferably used in a base station apparatus, a terminal apparatus, and a communication method.

1. A terminal apparatus for communicating with a base station apparatus, the terminal apparatus comprising:
a receiver configured to receive control information; and a transmitter configured to perform data transmission in accordance with the control information, wherein
the receiver receives at least RRC and DCI,
the RRC includes configuration of a target received power, a fractional TPC, and an index of a closed loop TPC to be used for PUSCH transmission, and information for indicating at least a target received power, a fractional TPC, and an index of a closed loop TPC as parameters for transmission power control to be switched depending on the DCI, and
in a case that the DCI for indicating switching of a transmission power value is detected, a transmission power used for data transmission is caused to be different from a transmission power value calculated using parameters notified as the parameters for transmission power control to be switched.

2. The terminal apparatus according to claim 1, wherein
the DCI for indicating the switching of the transmission power value is configured with at least one of conditions of a RNTI, an aggregation level, a search space, and the number of OFDM symbols used for data transmission that are configured through the RRC, and the transmission power control is switched in accordance with the condition.

3. The terminal apparatus according to claim 1, wherein
the DCI for indicating the switching of the transmission power value causes switching of the transmission power control in a case that a value of a Validation field in the DCI for activation of SPS Type 2 is different.

4. The terminal apparatus according to claim 1, wherein
the DCI for indicating the switching of the transmission power value indicates switching of at least one of an MCS table, a CQI table, or a transmission mode of a PH reporting.
